(19) United States
(12) Patent Application Publication
(10) Pub. No.: US 2014/0180714 A1
(43) Pub. Date: Jun. 26, 2014

(54) HEALTH QUANT DATA MODELER WITH HEALTH CARE REAL OPTIONS ANALYTICS, RAPID ECONOMIC JUSTIFICATION, AND AFFORDABLE CARE ACT ENABLED OPTIONS

(71) Applicants: Johnathan Mun, Dublin, CA (US); Thomas Michael Schmidt, Iowa City, IA (US)

(72) Inventors: Johnathan Mun, Dublin, CA (US); Thomas Michael Schmidt, Iowa City, IA (US)

(21) Appl. No.: 14/191,660

(22) Filed: Feb. 27, 2014

Related U.S. Application Data
(63) Continuation-in-part of application No. 13/786,786, filed on Mar. 6, 2013.
Application No. 13/786,786 is a continuation-in-part of application No. 14/016,650, filed on Sep. 3, 2013.
Application No. 14/016,650 is a continuation-in-part of application No. 14/016,666, filed on Sep. 3, 2013.
(60) Provisional application No. 61/612,941, filed on Mar. 19, 2012.
(60) Provisional application No. 61/696,394, filed on Sep. 4, 2012.
(60) Provisional application No. 61/696,392, filed on Sep. 4, 2012.

(51) Int. Cl. G06F 19/00

(52) U.S. Cl. CPC G06F 19/328; G06F 19/3431
USPC 705/2

(57) ABSTRACT

The present invention is applicable in the fields of finance, health care, employee benefits, math, and business statistics and was originated to provide real health-care decision analysis, risk analysis, and option analytics to corporate entities and individual participants, the need for which has arisen from what is collectively known as the Affordable Care Act (Patient Protection and Affordable Care Act as amended by the Health Care and Education Reconciliation Act of 2010). The present version of the Health Quant Data Modeler (HQDM) accounts for updates made necessary by the implementation of the Affordable Care Act, including additional applications for modeling, simulating, and analyzing the financial impact of the health-care real options for corporate entities with a minimal set of input assumptions for the purposes of a rapid economic justification and analysis.

### CROSS-REFERENCE TO RELATED APPLICATIONS

The application is a continuation-in-part of U.S. Non-Provisional Utility patent application Ser. No. 13/786,786, filed Mar. 6, 2013, which claims priority to U.S. Provisional Patent Application No. 61/612,941, filed Mar. 19, 2012, the entire disclosure of both is incorporated herein by reference.

The application is also a continuation-in-part of U.S. Non-Provisional Utility patent application Ser. No. 14/016,650, filed Sep. 3, 2013, which claims priority to U.S. Provisional Patent Application No. 61/696,394, filed Sep. 4, 2012, the entire disclosure of both is incorporated herein by reference.

The application is also a continuation-in-part of U.S. Non-Provisional Utility patent application Ser. No. 14/016,666, filed Sep. 3, 2013, which claims priority to U.S. Provisional Patent Application No. 61/696,392 filed Sep. 4, 2012, the entire disclosure of both is incorporated herein by reference.

### FIELD OF THE INVENTION

The present invention is applicable in the fields of finance, health care, employee benefits, math, and business statistics and was originated to provide real health-care decision analysis, risk analysis, and option analytics to corporate entities and individual participants, the need for which has arisen from what is collectively known as the Affordable Care Act (Patient Protection and Affordable Care Act as amended by the Health Care and Education Reconciliation Act of 2010). The present version of the Health Quant Data Modeler (HQDM) accounts for updates made necessary by the implementation of the Affordable Care Act, including additional applications for modeling, simulating, and analyzing the financial impact of the health-care real options for corporate entities with a minimal set of input assumptions for the purposes of a rapid economic justification and analysis.

### COPYRIGHT AND TRADEMARK NOTICE

A portion of the disclosure of this patent document contains materials subject to copyright and trademark protection. The copyright and trademark owner has no objection to the facsimile reproduction by anyone of the patent document or the patent disclosure, as it appears in the U.S. Patent and Trademark Office patent files or records, but otherwise reserves all copyrights whatsoever.

### BACKGROUND OF THE INVENTION

The following provides the background and context for this invention.

The history and growth of employer-sponsored health insurance in this country changed precipitously after World War II when health insurance enrollment grew from 21 million in 1940 to 143 million in 1950 directly as a result of government intervention by excluding this form of employee compensation from federal taxation. On Mar. 23, 2010, U.S. President Barack Obama signed into law the Patient Protection and Affordable Care Act as amended by the Health Care and Education Reconciliation Act of 2010, known as the Affordable Care Act (ACA), as a another form of government intervention that sets forth health-care policy changes intended to further expand insurance coverage in the United States.

Large employers are now required to provide at least 95% of their full-time employees minimum essential coverage (MEC) that provides the essential health benefits (EHB) at a minimum actuarial value of 60% within a minimum affordability requirement that self-only coverage for the full-time employee working 30 hours or more per week may not exceed 9.5% of their income.

Individuals are required to have the minimum essential coverage or be allowed to purchase at least bronze level coverage in order to meet the new individual shared responsibility requirement that includes a graduating penalty from 2014 to 2017 if they do not purchase coverage.

Insurance companies are now subject to medical loss ratio requirements that require rebates on excess profits generated when the medical claims loss ratios are below certain thresholds.

State governments have elected to build their own state-based Health Insurance Exchange or allow the federal government to operate the Exchange known as the Federally Facilitated Marketplace (FFM).

The federal government has expanded Medicaid where states have either accepted or rejected the expansion and further provided guidance on how the premium tax credit and cost-sharing reduction subsidy program for individuals whose incomes are between 100% and 400% of the their respective state's Federal Poverty Level tables (issued each January by Health and Human Services (HHS)) should be managed.

As corporate entities attempt to strategically manage their health-care expenditures, they are faced with assessing their health-care reform options. For example:
Abandonment Option. Will an employer decide that the nondeductible tax penalty and lost tax shields compared to their cost of offering or continuing to offer coverage is preferred and therefore elect to abandon employer-provided health insurance coverage?
Expansion Option. Is the attraction of new employees and the retention of existing employees the most significant argument for an employer to adopt, continue, or expand contributions or eligibility in the sponsorship of health insurance coverage?
Switching Option. The Marketplaces (aka Exchanges), by legislative design, are intended for individuals and small employers, and yet large employers are considering the option of using them in hybrid approaches, as a full replacement for providing employer-sponsored coverage, for their part-time employee and retiree populations. Is this a viable option for a large employer in spite of the fact these Exchanges are designed for individual and small group coverage and, if so, will there be a large-employer domino effect?
Stage-Gate Option. A typical employer offers its employees some choices, e.g., a standard option, high option, and a high deductible health plan option. According to the Office of Personnel Management, the federal government offers 207 different plan choices, but, as a practical matter, the choice for a federal employee is between six and fifteen plan options. Will employers with employees dispersed throughout the country determine that the Exchange constitutes more flexibility and plan options than their current health plan offerings? Will they elect to separate their plans by retaining employer-sponsored health insurance coverage for corporate and terminating coverage for a division in order to provide Exchange access?
Contraction Option. Defined contribution approaches using account-based funding have been used for retiree health benefits for many years now. Retirees are credited with a fixed-dollar amount for each year of plan participation or some variation of age plus years of service. The main advantage of establishing these types of accounts has been the predictability for the employers as they fund specific dollar amounts. The retirees assume the liability for the difference between the actual amount of coverage purchased in the market and the specific dollar amount funded by their employers. How will employers assess whether to move to such a defined contribution approach for their active population? Will they be able to preserve premium tax and cost-sharing subsidies in the process?

There are many additional issues that influence these options and will ultimately influence the decision about which option the employer will finally adopt. For example:
Premium Tax Credits. Premium tax credits and cost-sharing reductions are based on an each individual employee's income and the number of his or her dependents. Employers with higher salaries may determine that there will be minimal, if any, of these tax credits or subsidies for their employee population. However, employers with lower salaries may determine that there will be significant premium tax credits and cost-sharing reduction subsidies available for their employee population. How will an employer go about making this assessment as to whether its population will benefit from the premium tax credits, Medicaid, and cost-sharing reductions?
Self-Insurance Concerns. What recourse does an employer have when the plan can no longer place a dollar limit on an annual or lifetime basis for essential health benefit coverage and stop-loss coverage may not be available or too expensive? Will an employer simply decide to self-fund until a point where it is economically feasible to terminate its self-funded plan and migrate to the Exchange because the Exchange must accept the employer as a risk without regard to its historical claims experience? What happens if the stop-loss carrier non-renews at year end after reimbursement of a catastrophic claim?
Anti-Selection. Economic self-interest creates openings for an employer to break with groupthink. Employers are currently structuring contributions and models to migrate high-cost users into fixed-cost arrangements and low-cost users into variable-cost arrangements. This will play itself out into an analysis of an experience-rated versus a community-rated result. Will the employer anti-select such that it will use the Exchange for its retirees and part-time employees or find a way to shift high-cost users to the Exchange through organizational structures that will not be discriminatory?

The market is being altered resulting from the passage of this legislation. It is a fact that there is little health insurance competition in many states where one insurer claims half of the individual-and-small-group-fully insured market. What is less discussed is the national predominance of the Blue Cross Blue Shield Association, United Health Group, CIGNA, and Aetna coverage of over half of the covered population in the United States. It has been the history and practice of the insurance business to be built around relationship-based and transactional placements. Insurance carriers have built wholesale distribution channels around this high level of fragmentation. The advent of ACA's medical loss ratio requirement has now placed significant pressure on these insurers, and the current distribution channel may be set to fracture under the weight of the medical loss ratio requirements and heightened executive-level pressure on human resources departments to provide more value and analysis. As such, we anticipate a far greater level of disruption in the market than estimated by either the Office of the Actuary for CMS or the Congressional Budget Office, a position more closely aligned with McKinsey's conclusions.

Therefore, there is need in the art for a computer-implemented system and method for providing analysis that corporate entities need to assess their current arrangements and determine these corporate entities future “play” or “pay” positions. These and other features and advantages of the present invention will be explained and will become obvious to one skilled in the art through the summary of the invention that follows.

Related Art

The related art is represented by the following references of interest.

U.S. Pat. No. 8,095,392 (application Ser. No. 11/336,070 filed on Jan. 20, 2006) by Owen, Daniel L. (Los Altos, Calif.) (herein, “Owen”), describes a computer-implemented method for the execution of a risk-management application for performing decision logic that presents alternatives relating to a risk exposure of a family of a user; the risk-management application selected by the user from a plurality of different risk-management applications each capable of performing different decision logic and using different databases; retrieving first information from a database in accordance with the decision logic; and processing at least a portion of the first information in order to generate second information not originally included in the database. It should be noted that such asset risk management is defined to include management of any assets, cash flow, budgets, etc. that are affected by risk-mitigation instruments (e.g., health insurance, automobile insurance, life insurance, financial investments, long-term care insurance, home security devices, vehicle security devices, insurance, investments, etc.). Owen merely describes a design that helps to determine whether personal risks should be retained or transferred. Owen does not suggest any method of how to analyze employer-sponsored health insurance offerings, how to integrate individual and corporate health-care data into the running of forecasts and Monte Carlo risk simulations, or how to develop a plurality of strategic real options on making health-care insurance decisions. The Owen invention is strictly on the application of general risk management where data is collected and collated using computer-based logic to filter the data and perform relational database management tasks.

U.S. Pat. No. 8,090,562 (application Ser. No. 12/425,956 filed on Apr. 17, 2009) by Snider, James V. (Pleasanton, Calif.); Heyman, Eugene R. (Montgomery, Md.) (herein, “Snider”), describes a clinical evaluation for determination of disease severity and risk of major adverse cardiac events (MACE), e.g., mortality due to heart failure. It is useful for the prognostic evaluation of subjects, in particular for the prediction of adverse clinical outcomes, e.g., mortality, transplantation, and heart failure. Snider only applies to a clinical predictive modeling application through the use of biomarkers. Snider does not suggest how employer-sponsored health insurance offerings and their respective plan designs should be changed to improve outcomes. Snider strictly concerns the application of clinical management of key biomarkers to impact significant cardiac events, and that is not what this current invention is about.

U.S. Pat. No. 8,041,580 (application Ser. No. 12/039,131 filed on Feb. 28, 2008) by Sholtis, Steven (El Dorado Hills, Calif.), et al. (herein, “Sholtis”), describes a computer system-implemented method and process for forecasting the consequences of health-care utilization choices whereby health data associated with a user is obtained and analyzed to determine disease risk factors. The health-care utilization consequences report can include health-care recommendations, economic information, actuarial information, and comparisons between implementing/not implementing the health-care recommendations. Sholtis includes data representing information related to any historical and/or present user illnesses; data representing information related to any historical and/or present user injuries; data representing information related to any historical and/or present preventative health care received by the user; data representing information related to any historical and/or present medications taken by the user; data representing information related to any historical and/or present illness associated with the user's family and/or the user's family health history; data representing information related to any historical and/or present user residences; data representing information related to any historical and/or present user occupations; data representing information related to any historical and/or present user environmental exposures that could affect the user's predisposition to a particular type of disease; and/or data representing any other information related to the user's historical state of health or current state of health, or that is determined of value in projecting the user's future state of health. Sholtis describes a personal economic forecast of health-care consumption based on genetics, actual utilization history, demographic data, and personal family history. Sholtis is strictly for the application of personal health risk assessment.

U.S. Pat. No. 8,005,690 (application Ser. No. 11/835,593 filed on Aug. 8, 2007) by Brown, Stephen J. (Woodside, Calif.) (herein, “Brown”), describes the modeling and scoring risk assessment and a set of insurance products derived therefrom. Risk indicators are determined at a selected time. A population is assessed at that time and afterward for those risk indicators and for consequences associated therewith. Population members are coupled to client devices for determining risk indicators and consequences. A server receives data from each client and, in response thereto and in conjunction with an expert operator, (1) reassesses weights assigned to the risk indicators, (2) determines new risk indicators, (3) determines new measures for determining risk indicators and consequences, and (4) presents treatment options to each population member. The server determines, in response to the data from each client, and possibly other data, a measure of risk for each indicated consequence or for a set of such consequences. The expert operator uses this measure to determine either (1) an individual course of treatment, (2) a resource utilization review model, (3) a risk-assessment model, or (4) an insurance pricing model for each individual population member or for selected population subsets. Brown is a health risk-assessment tool that captures medical, psychological, and lifestyle questions along with biometric data to develop some form of a risk scoring application. Brown is not a health risk-assessment tool. Brown is strictly an application to assess personal risk factors that may be used to assess current courses of treatments and potentially be integrated into an insurance pricing model by loading premiums for higher risk factors.

U.S. Pat. No. 8,000,977 (application Ser. No. 10/799,042 filed on Mar. 11, 2004) by Achan, Pradeep Padmakshan (Castro Valley, Calif.) (herein, “Achan”), describes a method of and a system for development of health-care information systems (HIS). The method includes providing software programming interfaces for development of application modules, communication interfaces for establishing communication between various modules, and resource management interfaces for allocation of resources such as memory. Achan discloses a design for clinical information exchange between nurses, doctors, and the ward by capturing and sharing biometric, drug interaction, and drug and diet interaction information. Achan is strictly for the application of clinical information exchange.

U.S. Pat. No. 7,958,002 (application Ser. No. 12/607,838 filed on Oct. 28, 2009) by Bost, James (Washington, D.C.) (herein, “Bost”), describes a system and method for measuring the relative economic benefits from services offered by health-care plans. Bost is strictly for the measurement of NCQA health plans using productivity metrics.

U.S. Pat. No. 7,912,739 (application Ser. No. 10/691,762 filed on Oct. 23, 2003) by Colley, John Lawrence (Richmond, Va.), et al. (herein, “Colley”), describes a method for managing health plans and includes the use of theoretically derived mathematical models. The Colley method may be used in the analysis of health insurance products. The Colley method may also assist in the selection of a particular health plan's benefit and contribution strategy. The analysis may further be used in the selection of a health plan's funding arrangement. The system and methods described in Colley do not have the breadth and depth of trending and forecasting techniques for self-funded plan analysis, do not have a contribution optimization utility that both initially calculates an effective employer target percentage and can subsequently perform a reverse calculation of phantom rates based on a revised user update of an effective employer target percentage, have limited application to normal distribution versus a best fit among thirty or more distribution types, have adopted an inferior approach by not using a per member per month (PMPM) calculation methodology, and have mostly adopted subjective index valuations on benefit modeling valuation calculations that function as single point estimates of future plan value versus Monte Carlo risk simulations on plan costs based on various input assumptions. Colley is a benefits modeling application with single point comparative estimates on funding types and contribution structures.

U.S. Pat. No. 7,912,734 (application Ser. No. 11/679,267 filed on Feb. 27, 2007) by Kil, David H. (Santa Clara, Calif.) (herein, “Kil”), describes apparatuses, computer media, and methods for supporting the health needs of a consumer by processing input data. An integrated health management platform supports the management of health care by obtaining multidimensional input data for a consumer, determining a health-trajectory predictor from the multidimensional input data, identifying a target of opportunity for the consumer in accordance with the health-trajectory predictor, and offering the target of opportunity for the consumer. A health benefit plan is offered from a set of health benefit plan configurations. Responses are received from a questionnaire to members of a consumer group, and preferred health benefit plans chosen by members of the group are predicted. From the responses, an overall enrollment distribution is estimated. A plurality of health benefit plans is offered to the group when a minimum economic objective is obtained from the set of health benefit plan configurations. Kil is a predictive modeling risk-scoring application that uses claims data, self-reported data, consumer behavior marketing data, disease clustering, and disease progression probabilities as part of a methodology to develop health plan offerings by integrating trajectory valuations with consumer-preference and projected utility functions.

U.S. Pat. No. 7,813,937 (application Ser. No. 10/360,858 filed on Feb. 6, 2003) by Pathria, Anu K. (San Diego, Calif.), et al. (herein, “Pathria”), describes a transaction-based behavioral profiling, whereby the entity to be profiled is represented by a stream of transactions, which is required in a variety of data mining and predictive modeling applications. An approach is described for assessing inconsistency in the activity of an entity, as a way of detecting fraud and abuse, using service-code information available on each transaction. Pathria describes a fraud and detection health-care provider profiling application.

U.S. Pat. No. 7,769,600 (application Ser. No. 11/933,098 filed on Oct. 31, 2007) by Iliff, Edwin C. (La Jolla, Calif.) (herein, “Iliff”), describes a system and method for allowing a patient to access an automated process for managing a specified health problem called a disease. The system of Iliff performs disease management in a fully automated manner, using periodic interactive dialogs with the patient to obtain health state measurements from the patient, to evaluate and assess the progress of the patient's disease, to review and adjust therapy to optimal levels, and to give the patient medical advice for administering treatment and handling symptom flare-ups and acute episodes of the disease. Iliff describes a clinically based, personalized disease-management application to assist the individual in the long-term management of his or her disease. Iliff does not suggest a method of how to evaluate the effectiveness of population-based disease management programs.

U.S. Pat. No. 7,653,557 (application Ser. No. 11/315,054 filed on Dec. 22, 2005) by Sweetser, Christine B. (Linn Haven, Fla.) (herein, “Sweetser”), describes an advanced primary nurse care system, and a process is disclosed that is client-driven for processing a number of clients in a timely manner with enhanced health-care outcomes. The system and process of Sweetser are sized to provide an optimum patient flow and health care. The system and process of Sweetser include a computer network having a central system computer. A computer program resides on the system computer for creating a real-time client record as the client proceeds through the system and process. There is a client station connected in the computer network where the client record is initially created and accessed on subsequent visits using a unique client ID code. Sweetser is strictly a health-care operational application.

U.S. Pat. No. 7,555,438 (application Ser. No. 11/491,035 filed on Jul. 21, 2006) by Binns, Gregory S. (Lake Forest, Ill.); Blumberg, Mark Stuart (Oakland, Calif.) (herein, “Binns”), describes a method of model development for use in underwriting group life insurance for a policy period. The system and methods of Binns include collecting medical claims data for the group to be underwritten, where each medical claim is related to a particular employee of the group. Morbidity categories are provided that categorize the medical claims in the medical claims data. A conditional probability model is developed and applied to the morbidity categories for each employee in the group using his or her medical claims, thereby calculating the expected conditional probability for each employee dying during the policy period. For each employee, an estimate of the expected life claim cost is estimated using an index of the life coverage to salary. Combining the expected conditional probability for each employee dying during the policy period with the estimate of the expected claim cost of death gives an estimate of the group's total life exposure. The system and methods of Binns use medical claims in the underwriting of mortality and morbidity of group life insurance experience.

U.S. Pat. No. 7,493,264 (application Ser. No. 10/166,298 filed on Jun. 11, 2002) by Kelly, Miriam A. (Ridgewood, N.J.); Lotvin, Alan M. (Maple Grove, Minn.) (herein, “Kelly”), describes an interactive computer-assisted method that compiles comprehensive health-care information on patients in a central repository, assesses and analyzes this information, and identifies high utilizers of health-care services through use of a computer and a user associated therewith. The methods of Kelly include the step of creating a central repository of various databases containing patient information, including demographic information and behavior, and, optionally, the results of a core survey of health status questions. Kelly optionally involves the step of determining the appropriate core questions and the criteria to determine whether and when to ask certain questions of particular patients based on their response to prior questions. In summary, Kelly is a combination of a health risk-assessment questionnaire and a basis for a predictive modeling application.

U.S. Pat. No. 7,392,201 (application Ser. No. 09/861,379 filed on May 18, 2001) by Binns, Gregory S. (Wilmette, Ill.); Blumberg, Mark Stuart (Oakland, Calif.) (herein, “Binns-2”), describes a computer-implemented process of developing a person-level cost model for forecasting future costs attributable to claims from members of a book of business, where person-level data are available for a substantial portion of the members of the book of business for an actual underwriting period, and the forecast of interest for a policy period is disclosed. Binns-2 pertains to health, disability, and life insurance systems, particularly including processing data (in the business of health insurance) for estimating future costs or liability and setting optimal pricing.

U.S. Pat. No. 7,213,009 (application Ser. No. 10/658,998 filed on Sep. 9, 2003) by Pestrotnik, Stanley L. (Sandy, Utah), et al. (herein, “Pestrotnik”), describes a method for delivering decision-supported patient data to a clinician to aid the clinician with the diagnosis and treatment of a medical condition. The method of Pestrotnik includes presenting a patient with questions generated by a decision-support module and gathering patient data indicative of the responses to the questions. Each question presented to the patient is based on the prior questions presented and the patient data gathered from the patient. On receiving the patient data from the client module, the patient data is evaluated at the module to generate decision-supported patient data. This supported patient data includes medical condition diagnoses, pertinent medical parameters for the medical condition, and medical care recommendations for the medical condition. At the client module or a clinician's client module, this patient data is presented to the clinician in either a standardized format associated with a progress note or a format selected by the clinician. Pestrotnik describes a method for delivering decision-supported patient data to a clinician to aid the clinician with the diagnosis and treatment of a medical condition.

U.S. Pat. No. 6,381,576 (application Ser. No. 09/212,521 filed on Dec. 16, 1998) by Gilbert, Edward Howard (Plano, Tex.) (herein, “Gilbert”), describes a diagnostic and treatment information data structure that encapsulates, with or without identifying a specific patient, information regarding a particular diagnosis-treatment cycle for an individual patient. In Gilbert, the diagnostic and treatment information data structures for a number of diagnosis-treatment cycles may be combined within a database for analysis in outcomes or cost-effectiveness studies. A relational database that assists the health-care provider in formulating the diagnostic and treatment information data structure for a specific diagnosis-treatment cycle can, within a user interface, display information determined during the outcomes or cost-effectiveness studies to influence the health-care provider at the point of decision. Effective analyses of diagnostic, treatment, and outcomes information and guidance for health-care professionals based on such analyses is thus facilitated. An Internet/intranet database program employing the diagnostic and treatment information data structure contains both clinical and financial information permitting effective filtering and analysis of CPT codes as to accuracy and appropriateness. Gilbert merely describes an operational health-care provider clinical application that facilitates a diagnostic and treatment cycle.

U.S. Pat. No. 6,370,511 (application Ser. No. 09/188,986 filed on Nov. 9, 1998) by Dang, Dennis K. (Phoenix, Ariz.) (herein, “Dang”), describes a computer-implemented method for profiling medical claims to assist health-care managers in determining the cost efficiency and service quality of health-care providers. The Dang method allows an objective means for measuring and quantifying health-care services. An episode treatment group (ETG) is a patient classification unit that defines groups that are clinically homogenous (similar cause of illness and treatment) and statistically stable. The ETG methodology uses service or segment-level claim data as input data and assigns each service to the appropriate episode. The program identifies concurrent and recurrent episodes, flags records, creates new groupings, shifts groupings for changed conditions, selects the most recent claims, resets windows, makes a determination if the provider is an independent lab, and continues to collect information until an absence of treatment is detected. Dang merely describes an application associated with the development of early evidence-based medicine guidelines through the creation of episode treatment groups.

Updated Regulations

Following on the passage of the Affordable Care Act (Patient Protection and Affordable Care Act as amended by the Health Care and Education Reconciliation Act of 2010) on Mar. 23, 2010, various departments and agencies of the federal government have issued regulations implementing the legislation. The updates included within the present invention are primarily designed to incorporate the following regulations.

Health Insurance Premium Tax Credit (Department of the Treasury, Internal Revenue Service, 26 CFR Parts 1 and 602, [TD 9590], RIN 1545-BJ82, AGENCY: Internal Revenue Service (IRS), Treasury, Federal Register/Vol. 77, No. 100/Wednesday, May 23, 2012, Page 30392). According to this rule, the applicable percentage multiplied by a taxpayer's household income determines the taxpayer's required share of premiums for the benchmark plan. This required share is subtracted from the adjusted monthly premium for the applicable benchmark plan when computing the premium assistance amount. The applicable percentage is computed by first determining the percentage that the taxpayer's household income bears to the Federal poverty line for the taxpayer's family size. The resulting Federal poverty line percentage is then compared to the following income categories: For incomes calculating less than 133% of the Federal Poverty Level, the initial percentage is 2.0%. For incomes calculating at least 133%, but less than 150% of the Federal Poverty Level, the initial percentage is 3.0% and the final percentage is 4.0%. For incomes calculating at least 150%, but less than 200% of the Federal Poverty Level, the initial percentage is 4.0% and the final percentage is 6.3%. For incomes calculating at least 200%, but less than 250% of the Federal Poverty Level, the initial percentage is 6.3% and the final percentage is 8.05%. For incomes calculating at least 250%, but less than 300% of the Federal Poverty Level, the initial percentage is 8.05% and the final percentage is 9.5%. For incomes calculating at least 300%, but less than 400% of the Federal Poverty Level, the initial percentage is 9.5% and the final percentage is 9.5%. An applicable percentage within an income category increases on a sliding scale in a linear manner and is rounded to the nearest one-hundredth of one percent.

Minimum Value of Eligible Employer-Sponsored Plans and Other Rules Regarding the Health Insurance Premium Tax Credit (Department of the Treasury Internal Revenue Service, 26 CFR Part 1, [REG-125398-12], RIN 1545-BL43, AGENCY: Internal Revenue Service (IRS), Treasury, Federal Register/Vol. 78, No. 86/Friday, May 3, 2013, Page 25910). Section 36B(b)(1) provides that the premium assistance credit amount is the sum of the premium assistance amounts for all coverage months in the taxable year for individuals in the taxpayer's family. The premium assistance amount for a coverage month is the lesser of (1) the premiums for the month for one or more qualified health plans that cover a taxpayer or family member or (2) the excess of the adjusted monthly premium for the Second-Lowest Cost Silver Plan (as described in section 1302(d)(1)(B) of the Affordable Care Act (42 U.S.C. 18022(d)(1)(B)) (the benchmark plan) that applies to the taxpayer over 1/12 of the product of the taxpayer's household income and the applicable percentage for the taxable year.

Health Insurance Premium Tax Credit (Department of the Treasury, Internal Revenue Service, 26 CFR Part 1, [TD 9611], RIN 1545-BL49, AGENCY: Internal Revenue Service (IRS), Treasury. Federal Register/Vol. 78, No. 22/Friday, Feb. 1, 2013, Page 7265). The proposed regulations provided that, for taxable years beginning before Jan. 1, 2015, an eligible employer-sponsored plan is affordable for related individuals if the portion of the annual premium the employee must pay for self-only coverage (the required contribution percentage) does not exceed 9.5% of the taxpayer's household income. The final regulations adopted the proposed rule without change.

Shared Responsibility Payment for Not Maintaining Minimum Essential Coverage (Department of the Treasury, Internal Revenue Service, 26 CFR Parts 1 and 602, [TD 9632], RIN 1545-BL36, AGENCY: Internal Revenue Service (IRS), Treasury, Federal Register/Vol. 78, No. 169/Friday, Aug. 30, 2013, Page 53659). According to this rule, in the case of an employee who is eligible to purchase coverage under an eligible employer-sponsored plan sponsored by the employee's employer, the required contribution is the portion of the annual premium that the employee would pay (whether through salary reduction or otherwise) for the lowest cost self-only coverage.

Patient Protection and Affordable Care Act; Amendments to the HHS Notice of Benefit and Payment Parameters for 2014 (Department of Health and Human Services, 45 CFR Parts 153 and 156, [CMS-9964-IFC], RIN 0938-AR74, AGENCY: Centers for Medicare & Medicaid Services (CMS), Department of Health and Human Services (HHS), Federal Register/Vol. 78, No. 47/Monday, Mar. 11, 2013, Page 15481). For individuals with household incomes of 250% to 400% of the Federal Poverty Level, it is noted that without any change in other forms of cost sharing, any reduction in the maximum annual limitation on cost sharing will cause an increase in actuarial value. Therefore, it has been proposed not to reduce the maximum annual limitation on cost sharing for individuals with household incomes between 250% and 400% of the Federal Poverty Level.

### SUMMARY OF THE INVENTION

Accordingly, embodiments of the present invention are configured to preempt this result by promoting the analysis that will lead to a more rapid adoption of alternatives to employer-sponsored health insurance. Preferred embodiments of the present invention simulate data from numerous and distinct user input elements in order to provide an objective and strategic risk-based real options decision analysis.

The present invention, with its preferred embodiment encapsulated within a Health Quant Data Modeler (HQDM) software, is applicable for the types of analyses that corporate entities need to assess their current arrangements and determine their future “play” or “pay” positions. In certain embodiments, a HQDM is both a stand-alone and server-based set of software modules and advanced analytical tools that are used in an innovative way that links various databases and data sources to integrate forecasting calculations, strategic real options, and Monte Carlo risk simulation. One of ordinary skill in the art would appreciate that there are numerous configurations that could be utilized in conjunction with a HQDM, and embodiments of the present invention are contemplated for use with any configuration.

### BRIEF DESCRIPTION OF THE DRAWINGS

FIG. 1 illustrates a schematic overview of a computing device, in accordance with an embodiment of the present invention.

FIG. 2 illustrates a network schematic of a system, in accordance with an embodiment of the present invention.

FIG. 3 illustrates the algorithm for the premium tax credit calculation process used for each employee based upon the Medicaid expansion status of their census-based state of residence.

FIG. 4 illustrates the linear sliding scale used in the premium tax credit calculation process.

FIG. 5 illustrates the premium tax credit basis options used for illustration within the utility.

FIG. 6 illustrates the exceptions report used in the evaluation of options to correct for the failure of an employer contribution strategy with respect to the minimum affordability requirement of the Affordable Care Act.

FIG. 7 illustrates the Input Assumptions for the HQDM Lite (Rapid Economic Justification) Version.

FIG. 8 illustrates the Economic Results for the HQDM Lite (Rapid Economic Justification) Version.

FIG. 9 illustrates the Indifference Analytics for the HQDM Lite (Rapid Economic Justification) Version.

FIG. 10 illustrates the Simulation Analytics for the HQDM Lite (Rapid Economic Justification) Version.

FIG. 11 illustrates the Employer Tax Shift algorithm for the imputed income calculation when employer-sponsored insurance is terminated.

FIG. 12 illustrates the Expand Income algorithm that is used as a replacement for calendar gross wages when selected.

FIG. 13 illustrates the Expand Tax Credit algorithm that is used for the calculation of premium tax credits based on the number of dependents.

FIG. 14 illustrates the Allocation options for the distribution of option savings.

### DETAILED DESCRIPTION OF THE INVENTION

According to an embodiment of the present invention, the computer-implemented system and methods herein described may be configured to utilize one or more sets of models and algorithms. A preferred embodiment of the present invention has the ability to perform Monte Carlo risk-based simulations, forecasting, fit of existing data, optimization to allocate employer- and employee-based contributions, and linking from and exporting to existing databases and data files.

According to an embodiment of the present invention, the HQDM may be used for all of its components (i.e., forecasting, strategic real options, and Monte Carlo risk simulation) or for its real options component alone. The HQDM may be configured as (i) a stand-alone set of software modules, (ii) a server-based set of software modules, (iii) an advanced analytical tool set that is used integrate real options modeling and simulation, or (iv) any combination thereof. In certain embodiments, the HQDM Lite, or rapid economic justification, may be attached to a HQDM as an option for the employees of a population or as a detached capability.

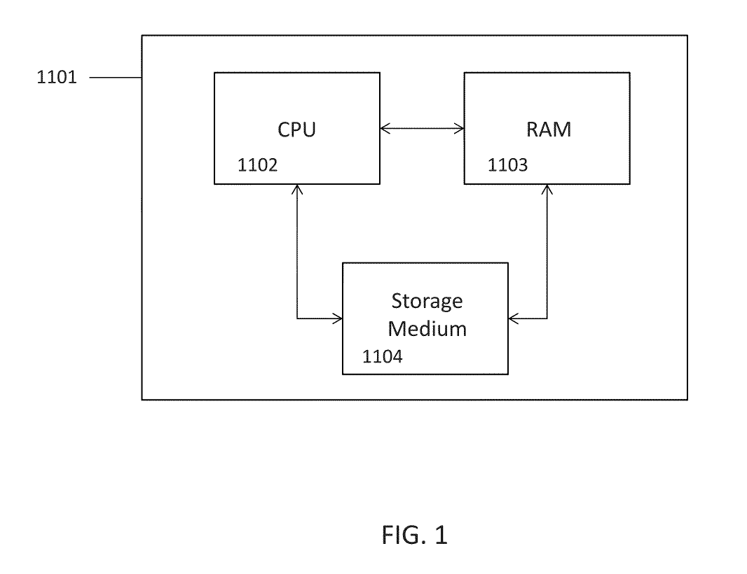

According to an embodiment of the present invention, the system and method is accomplished through the use of one or more computing devices. As shown in FIG. 1, one of ordinary skill in the art would appreciate that a computing device 1101 appropriate for use with embodiments of the present application may generally be comprised of one or more of a Central Processing Unit (CPU) 1102, Random Access Memory (RAM) 1103, and a storage medium (e.g., hard disk drive, solid state drive, flash memory, cloud storage) 1104. Examples of computing devices usable with embodiments of the present invention include, but are not limited to, personal computers, smartphones, laptops, mobile computing devices, tablet PCs, and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured, and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however, a user may be able to compose data offline that will be consumed by the system when the user is later connected to a network.

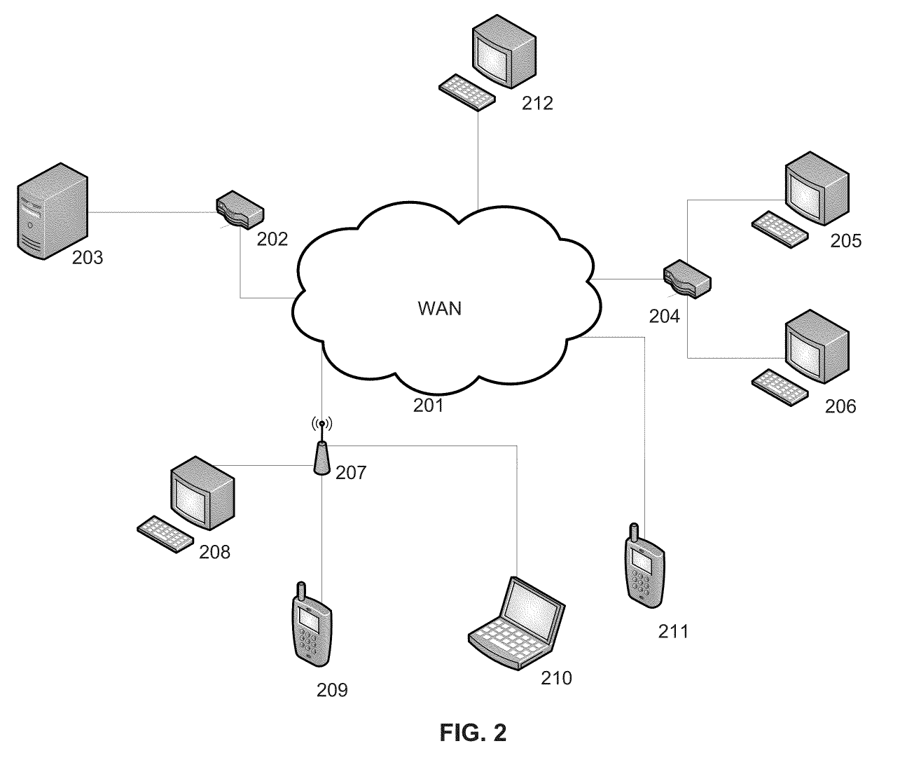

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in a server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201, or directed through one or more routers 202. Router(s) 202 are completely optional, and other embodiments in accordance with the present invention may or may not utilize one or more routers 202. One of ordinary skill in the art would appreciate that there are numerous ways servers 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system (i) through a computing device 212 directly connected to the WAN 201, (ii) through a computing device 205, 206 connected to the WAN 201 through a routing device 204, (iii) through a computing device 208, 209, 210 connected to a wireless access point 207, or (iv) through a computing device 211 via a wireless connection (e.g., CDMA, GMS, 3G, 4G) to the WAN 201. One of ordinary skill in the art would appreciate that there are numerous ways that a component may connect to a server 203 via WAN 201 or other network, and embodiments of the present invention are contemplated for use with any method for connecting to a server 203 via WAN 201 or other network. Furthermore, a server 203 could be comprised of a personal computing device, such as a smartphone, acting as a host for other computing devices to connect to.

Medicaid Expansion Status and Linear Sliding Scale

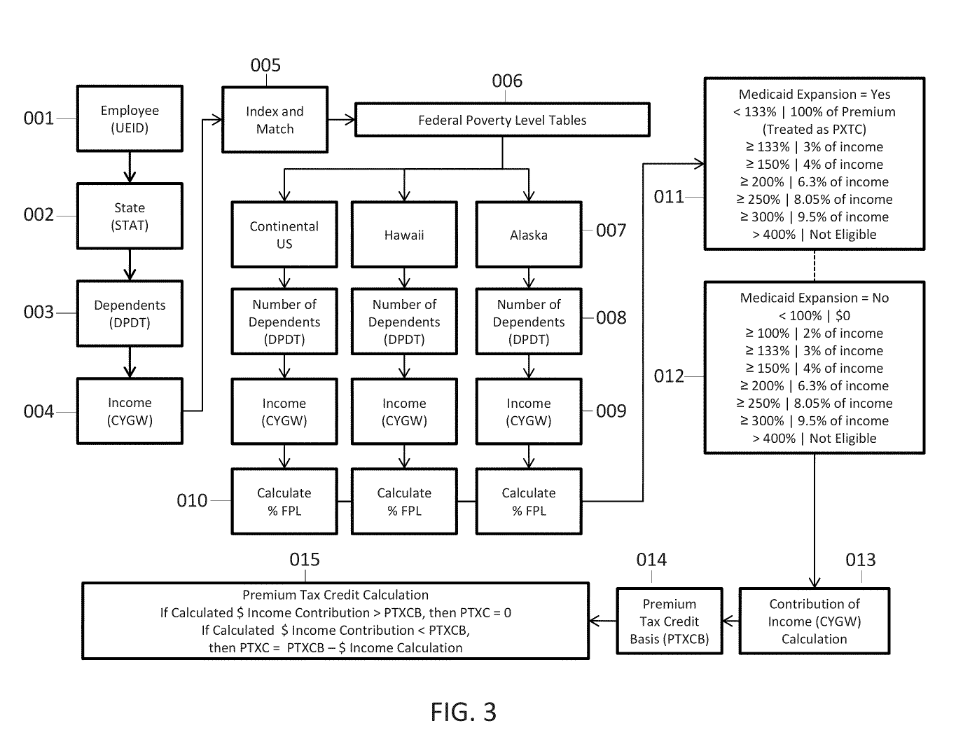

According to a preferred embodiment of the present invention, the first step in calculating the premium tax credit amount is (as shown in FIG. 3) to determine eligibility by identifying each individual 001, their state of residency 002, the number of dependents 003, and their income 004. The next step is to index and match 005 to the Federal Poverty Level (FPL) tables 006 the appropriate (i) state of residency 007 (continental United States, Hawaii, and Alaska), (ii) the number of dependents 008, and (iii) income 009, and calculate the ratio of the income to the Federal Poverty Level tables 010. The process splits into Medicaid expansion calculations 011 and non-Medicaid expansion calculations 012 in determining the maximum percentage of income 013 an employee may contribute, the premium tax credit basis 014, and the final premium tax credit calculated amount for each individual 015. In the preferred embodiment, the first step has been configured to account for the decisions made by each state with respect to whether it has agreed or not agreed to the expansion of Medicaid and document this updated process in determining the premium tax credits 015 as well as documenting the adoption and integration of the IRS guidelines in the use of a linear sliding scale in the premium tax credit calculation process. See FIG. 3. In the preferred embodiment, those states 005 that have agreed to the Medicaid expansion 011 may be separated from those that have not agreed to the Medicaid expansion 012, thereby allowing the utility to automatically map each individual user to the appropriate premium tax credit calculation algorithm based on that user's state of residence. See FIG. 3.

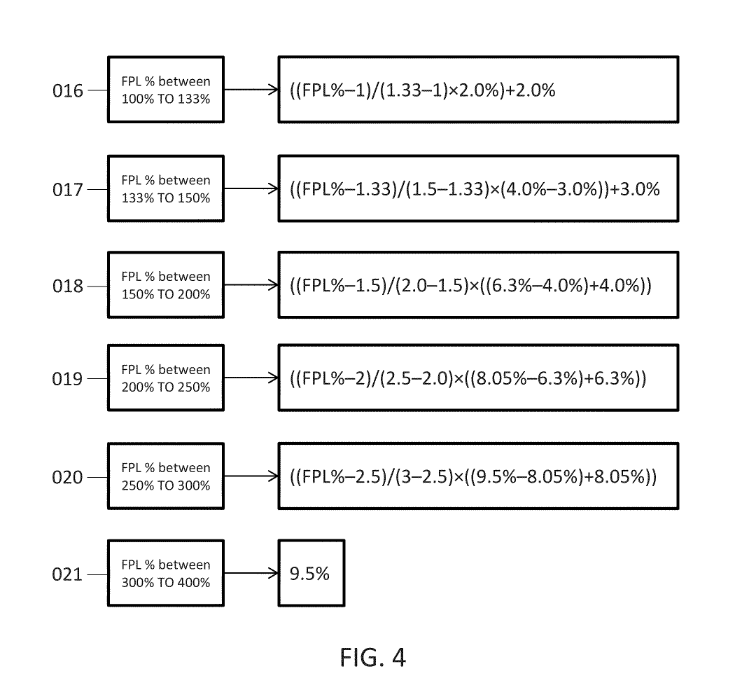

According to an embodiment of the present invention, the system and method may be used to calculate tax credit information for users in states that have agreed to Medicaid Expansion. In a preferred embodiment, for those states that have agreed to the Medicaid Expansion, the following calculation methodology may be applied in illustrating the premium tax credit amount within the utility. First, the system of the present invention calculates 100% of the premium that is designated as the premium tax credit cost basis (single/family proxy rates or second-lowest cost premium if the census has been expanded to incorporate the ages of the additional dependents) as the premium tax credit amount for those individuals eligible for Medicaid Expansion resulting from their incomes calculating at between 0% and 133% of the Federal Poverty Level 016. These individuals would automatically be enrolled in either a Medicaid plan or an approved HHS accepted state-based alternative that is 100% financed between the state and the federal government upon an Exchange-based eligibility determination process. For those individuals not enrolled in Medicaid, the maximum amount of income they would be allowed to contribute toward the cost of coverage and used as the basis for premium tax credit determinations is shown in FIG. 4. For the incomes calculating at least 133%, but less than 150% of the Federal Poverty Level 017, the initial percentage is 3.0% and the final percentage is 4.0% applying the linear sliding scale; for incomes calculating at least 150%, but less than 200% of the Federal Poverty Level 018, the initial percentage is 4.0% and the final percentage is 6.3% applying the linear sliding scale; for incomes calculating at least 200%, but less than 250% of the Federal Poverty Level 019, the initial percentage is 6.3% and the final percentage is 8.05% applying the linear sliding scale; for incomes calculating at least 250%, but less than 300% of the Federal Poverty Level 020, the initial percentage is 8.05% and the final percentage is 9.5% applying the linear sliding scale; and for incomes calculating at least 300%, but less than 400% of the Federal Poverty Level 021, the initial percentage is 9.5% and the final percentage is 9.5% applying the linear sliding scale.

According to an embodiment of the present invention, the system and method may be used to calculate tax credit information for users in states that have not agreed to Medicaid Expansion. In a preferred embodiment, for those states that have not agreed to the Medicaid Expansion, the following calculation methodology may be applied in illustrating a premium tax credit amount within the utility. Specifically, the system of the present invention populates the premium tax credit amount with a zero for those individuals whose income is between 0% and 100% of the Federal Poverty Level as they are not eligible for the Medicaid expansion. The premium tax credits are available only for those individuals whose income is between 100% and 400% of the Federal Poverty Level where the system bases the premium tax credit cost basis on either the single/family proxy rates or second-lowest cost premium if the census has been expanded to incorporate the ages of the additional dependents. The maximum amount of income they would be allowed to contribute toward the cost of coverage and used as the basis for premium tax credit determinations is shown in FIG. 4. For incomes calculating at least 100%, but less than 133% of the Federal Poverty Level 016, the initial percentage is 2.0% and the final percentage is 3.0% applying the linear sliding scale; for incomes calculating at least 133%, but less than 150% of the Federal Poverty Level 017, the initial percentage is 3.0% and the final percentage is 4.0% applying the linear sliding scale; for incomes calculating at least 150%, but less than 200% of the Federal Poverty Level 018, the initial percentage is 4.0% and the final percentage is 6.3% applying the linear sliding scale; for incomes calculating at least 200%, but less than 250% of the Federal Poverty Level 019, the initial percentage is 6.3% and the final percentage is 8.05% applying the linear sliding scale; for incomes calculating at least 250%, but less than 300% of the Federal Poverty Level 020, the initial percentage is 8.05% and the final percentage is 9.5% applying the linear sliding scale; and for incomes calculating at least 300%, but less than 400% of the Federal Poverty Level 021, the initial percentage is 9.5% and the final percentage is 9.5% applying the linear sliding scale.

Second-Lowest Cost Silver Plan Matrix

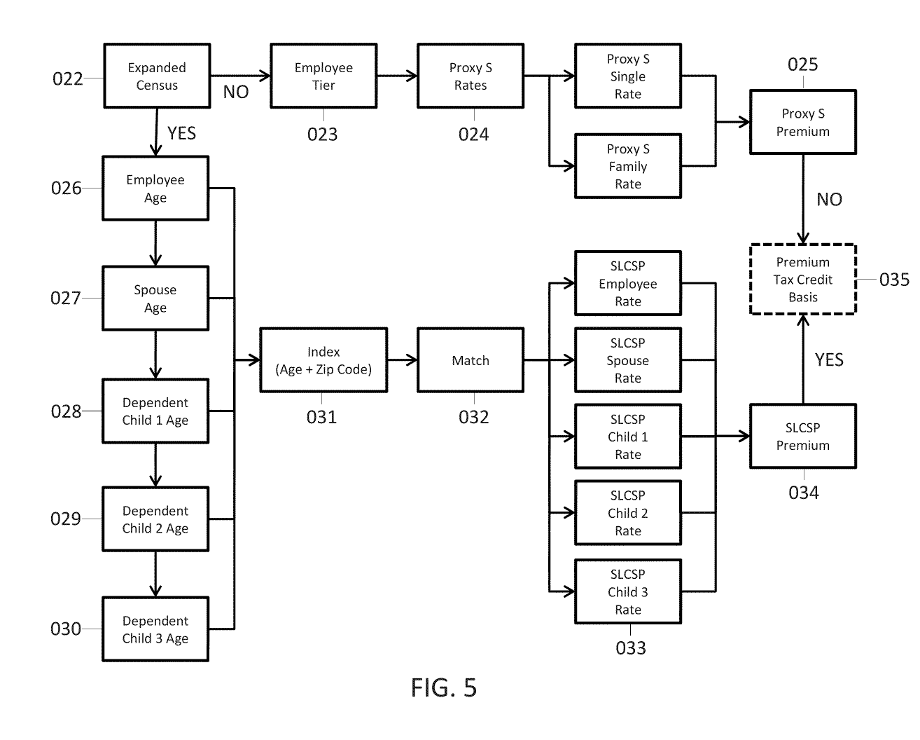

According to an embodiment of the present invention, the system and method of the present invention is amending the second step for the source of the premium in determining the rates for use as those of the second-lowest cost silver plan. In a preferred embodiment, there may be a choice given to use (i) a Proxy approach when the census data does not include additional age data for the dependents or (ii) the Second-Lowest Cost Silver Plan (SLCSP) approach, which uses the expanded census data that includes the additional age data for the dependents in determining the second-lowest cost silver plan using the proprietary SLCSP Matrix. As shown in FIG. 5, the process begins with determining whether there is an expanded census (expanded to incorporate the ages of the additional dependents) 022. If NO, the process is to map the tiers of coverage 023 to the respective Office of Personnel Management's [OPM] Blue Cross Blue Shield Standard Rates 024 retained for use as the Proxy Silver plan rates for the development of the Proxy S premium 025. If YES, the process is to upload the ages of the employee 026, spouse 027, the oldest first dependent child 028, the next oldest second dependent child 029, and the third oldest dependent child 030 and subsequently index the age and zip code 031 and match 032 each individual to their respective rate 033 sourced from the proprietary Second-Lowest Cost Silver Plan Matrix of rates that have been built from the rates submitted by each Qualified Health Plan Issuer (QHP) for each state-based, state/federal partnership, and federally facilitated marketplace exchange. This proprietary rating matrix is populated with rates sourced from each of the individual marketplace exchanges using the prescribed CMS-defined geographic rating areas; five-digit zip codes for the U.S.; ages of employee, spouse, and dependents; and silver plan rates as both reported to HHS and the state insurance departments and used within the Exchanges. The SLCSP rates are summed 034 with the prescribed limit not to exceed three dependent children in the calculation. The premium tax credit basis 035 is then populated with the appropriate premium based upon the expanded census election 022.

Exceptions Report

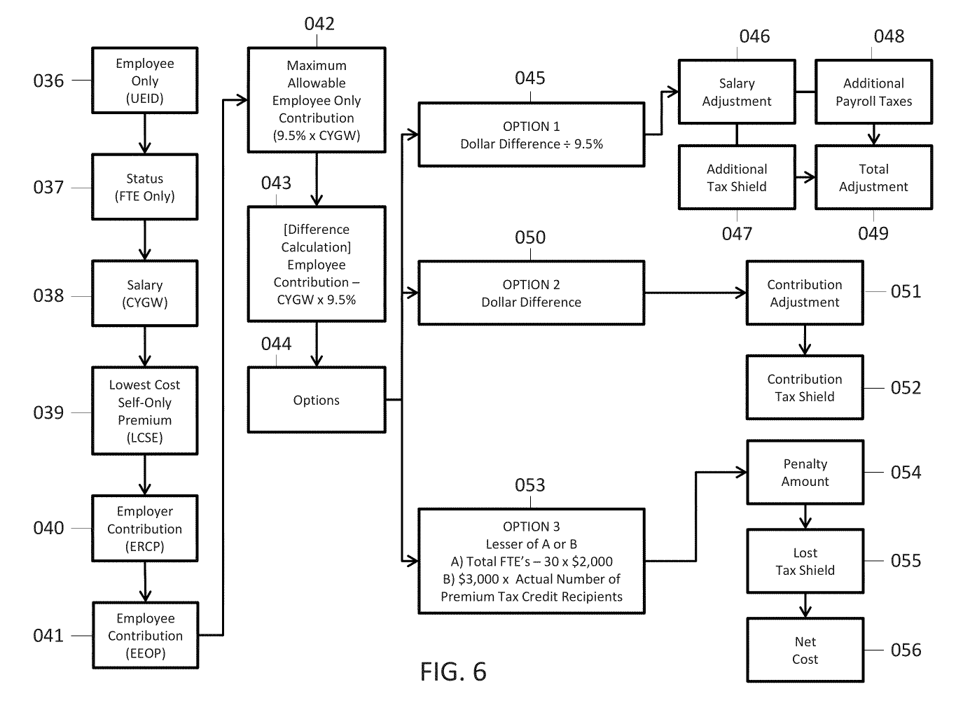

According to an embodiment of the present invention, the system and method may also calculate an Exceptions Report (FIG. 6). In a preferred embodiment of the present invention, the Exception Report illustrates the process in calculating the costs for a salary adjustment option, a contribution adjustment option, and a penalty payment option incorporating new tax shields, additional tax liabilities, and lost tax shields. In the preferred embodiment, income data for the employee-only and the lowest cost self-only premium rate for employee-only coverage is extracted to perform a calculation that determines whether the employer's contribution strategy meets the minimum affordability requirements where coverage for an employee under an employer-sponsored plan is deemed affordable if the employee's required contribution (within the meaning of section 5000A(e)(1)(B) of the Internal Revenue Code) for self-only coverage does not exceed 9.5% of the employee's household income for the taxable year. Calendar year wages from the census data are used as the basis for household income and in the calculation to determine whether the employer's contributions for the lowest cost self-only premium are not greater than the 9.5% threshold that meets the minimum affordability requirement. The extract lists by employee a complete list of all employees or only those employees whose contributions are greater than the 9.5% threshold. In the preferred embodiment, the Exceptions Report takes this extract and performs calculations to illustrate the following three options on how an employer may elect to move forward with respect to the minimum affordability requirement: Salary Adjustment (Option 1), Contribution Adjustment (Option 2), and Penalty Payment Assumption (Option 3). As shown in FIG. 6, the process begins with identifying the employee 036, determining whether the employee is full time or part time 037, sourcing their salary or income 038, uploading the employer's lowest-cost self-only premium 039, calculating the actual employer dollar contribution toward employee-only coverage 040, and then deducting the actual employer contribution from the lowest-cost self-only premium to determine the employee contribution 041 to be used as the basis for finalizing whether the employee's contribution is less than, equal to, or greater than the maximum 9.5% of the employee income threshold 042. When the employee contribution is greater than 9.5% of income, the excess 043 (difference between the actual contribution and the maximum allowable contribution) is then used for the development of options 044.

According to an embodiment of the present invention, Option 1 takes the dollar difference and divides it by the 9.5% threshold to determine the minimum salary adjustment required to correct the failure issue for (those employees whose contributions exceeded the minimum affordability requirement) 045. This adjusted salary less the current salary is the salary adjustment amount 046. The additional tax shield realized from the deductibility of the additional compensation is calculated as a deduction 047. The additional payroll taxes for the additional compensation paid out to the specific employees requiring the adjustment under this option are calculated as an additional tax liability 048. The salary adjustment less the tax shield plus the additional tax liability is the net total adjustment under this option 049.

According to an embodiment of the present invention, Option 2 takes the dollar difference 050 and directly applies a dollar-for-dollar contribution amount 051 to adjust the contribution for each individual to meet the minimum affordability threshold of 9.5% of self-only coverage as a percentage of employee-only income. To determine the net cost, the contribution tax shield is calculated 052 and is deducted from the dollar contribution amount.

According to an embodiment of the present invention, Option 3 determines the cost of this option by taking the lesser of the two calculations to determine the penalty tax amount. The first calculation 053 (A) is the total number of full-time employees minus the first 30 employees multiplied by $2,000. The second calculation 053 (B) is total number of employees that do not meet the minimum affordability test and where each is assumed to be a premium tax credit recipient, multiplied by $3,000. The appropriate penalty amount is reported 054. The lost tax shield is calculated using the corporate effective tax rate from the user's input and multiplying this rate by the penalty amount 055. The penalty amount and the lost tax shield are then added together to determine the net cost of the option 056.

Rapid Economic Justification: HQDM Lite

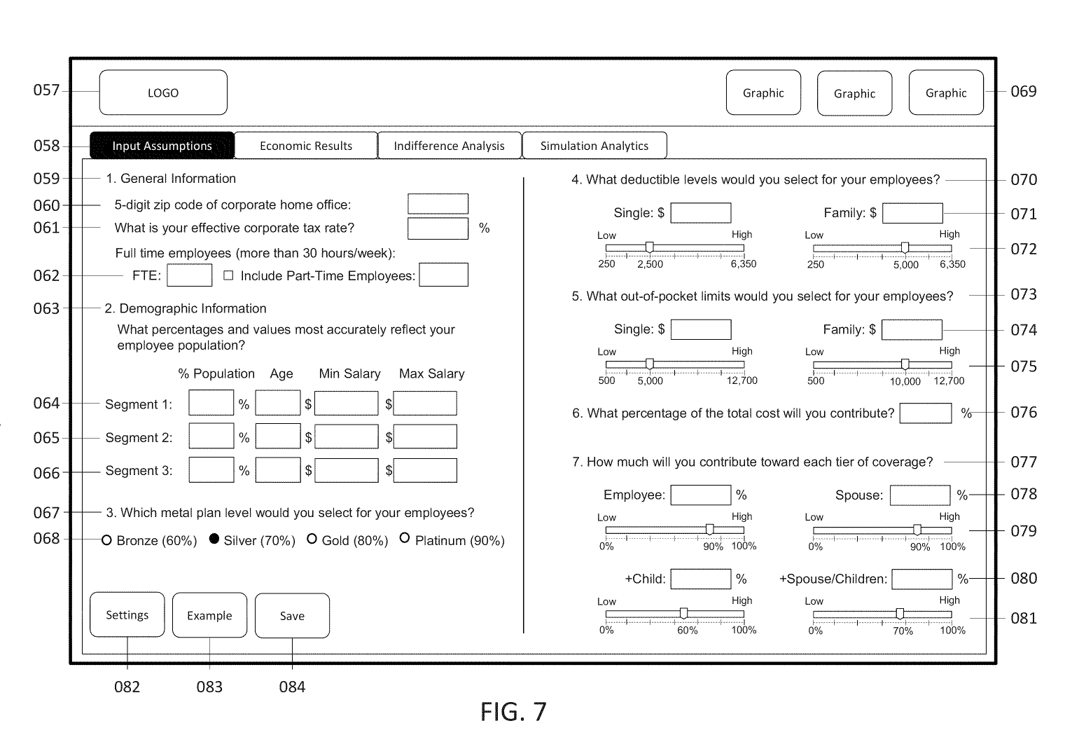

According to an embodiment of the present invention, the HQDM may further include a Rapid Economic Justification application. In a preferred embodiment, that application may be referred to as the Lite Version, or HQDM Lite. See FIGS. 7, 8, 9, and 10. This version adds to HQDM a simplified user interface with four tabs: Input Assumptions, Economic Results, Indifference Analysis, and Simulation Analytics

According to an embodiment of the present invention, the HDQM Lite will have an Input Assumptions Tab. In a preferred embodiment of the present invention, this tab (FIG. 7) provides for a custom user logo 057, customized user-specific graphics 069, and other clickable tab headings 058. In the preferred embodiment, the process begins by answering general questions 059, demographic questions 063, plan value 067, plan attributes 070, 073, and financial assumptions 076, 077 to be selected by the user and entered as inputs. In the preferred embodiment, behind the data inputs are pre-defined probability distributions where the system of the present invention uses Monte Carlo risk simulations to develop randomly generated representative populations based upon the user inputs and answers to the questions pertaining to these inputs. These representative sets of populations are then used to source rates from a customizable matrix of plans. The present invention then applies additional Monte Carlo risk simulation techniques that will lead to the Economic Results Tab.

Question 1 (General Information) 059. According to an embodiment of the present invention, the general information section requires the five-digit zip code 060 for the corporate home office, the percentage effective corporate tax rate 061 for the employer, the number of full-time employees 062 who work 30 hours or more per week for inclusion in the model, and whether part-time employees should be included in the calculation, and if so, the part-time employee count is required.

Question 2 (Demographic Information) 063. According to an embodiment of the present invention, demographic inputs are designed to reflect the employee population of the company. In a preferred embodiment, there are at least three segmentations 064, 065, 066 of the population that may be defined by the employer. In alternate embodiments, additional segments may be entered as required. In the preferred embodiment, each segment is defined by a minimum age and a maximum age band for employees in the segment (e.g., Segment 1 might represent employees between 18 and 30). Inputs are then entered for each segment. Population % is the percentage of each segment to the total for all three segments (all segments added total 100%). Age is the average age of the employees within the specific segments or age bands. Minimum and maximum salaries are the lower and upper limits within the segment or age bands.

Question 3 (Plan Values) 067. According to an embodiment of the present invention, the system uses the metal plan level categories within the postreform standardization of the nomenclature to describe the general actuarial plan value levels. In a preferred embodiment, the requirement is a selection that defines the general financial appetite the employer has with respect to the employer-sponsored insurance plan offering it would elect for its employees. In the preferred embodiment, the four levels 068 used are bonze (60%), silver (70%), gold (80%), and platinum (90%), with the silver plan level set as the default.

Question 4 (Deductibles) 070. According to an embodiment of the present invention, the deductible selection consists of single and family tiers where values may be manually entered 071 or a slider 072 may be used to select an amount that sources the nearest value from among the customized matrix of plan options.

Question 5 (Out-of-Pocket Limits) 073. According to an embodiment of the present invention, the out-of-pocket selection consists of single and family tiers where values may be manually entered 074 or a slider 075 may be used to select an amount that sources the nearest value from among the customized matrix of plan options.

Question 6 (Employer Contribution) 076. According to an embodiment of the present invention, an employer contribution is the effective percentage of the total premium the employer targets as its contribution.

Question 7 (Tier Structure) 077. According to an embodiment of the present invention, an employer is able to elect how to make its contribution. In a preferred embodiment, the structure is set such that the employer may define how much, as a percentage, it would contribute toward the cost of coverage for the employee-only situation 078, the addition of one dependent spouse 078, the addition of one dependent child 080, and the addition of a spouse with a child or more than one dependent children 080. In the preferred embodiment, the sliders may be used to select the percentage for employee only and one dependent spouse 079 and the addition of one dependent child or a spouse with a child or more than one dependent child 081. The percentage for each tier is used in concert with the employer contribution percentage 077 to develop the results. In the preferred embodiment, the capability to change settings 082 (e.g., the age band for each segment, the total number of segments, etc.), load an example 083, and save 084 the results are functions integrated into this tab.

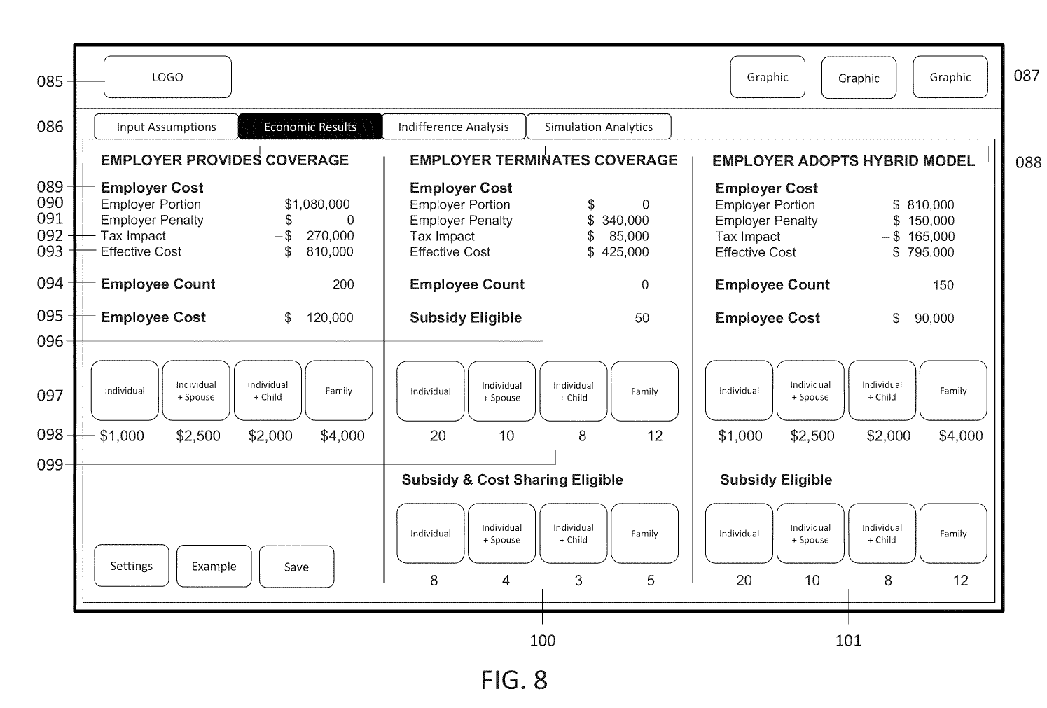

According to an embodiment of the present invention, the HDQM Lite will have an Economic Results Tab. In a preferred embodiment of the present invention, this tab (FIG. 8) provides for a custom user logo 085, graphics 087 and other clickable tab headings 086. In the preferred embodiment, the process continues from the prior Input Assumptions tab and is designed to provide a high-level view of three outcomes 088. The first is the retention of an employer-sponsored insurance health insurance offering to its employees (Option A, Employer Provides Coverage), the second is the termination of an employer-sponsored health insurance offering to its employees (Option B, Employer Terminates Coverage), and the third is a hybrid model offering that combines a continuation of an employer-sponsored health insurance offering to one group of employees and the effective discontinuation of an employer-sponsored health insurance offering to another group of employees (Option C, Employer Adopts Hybrid Model).

Option A (Employer Provides Coverage) 088. According to an embodiment of the present invention, this option illustrates the cost for the employer 089 providing employer-sponsored group coverage to its employees. The total cost of coverage is the employer portion 090 plus the employee cost 095. The employer's cost is the amount of the total premium 090 it would contribute less the tax shield 092 resulting in the net effective cost 093. No employer penalty 091 is illustrated as the assumption in the model is that the employer provides minimum essential coverage and the contribution structure meets the minimum affordability requirements under the Affordable Care Act. The total employee count 094 includes full-time and part-time employees if elected in the Input Assumptions tab. The cost for the employees 095 is based upon the difference between the employer's contribution and the total cost of coverage. Each coverage tier 097 is graphically highlighted and the effective dollar contribution 098 is calculated by aggregating all employee contributions and dividing this amount by the total number of employees within the tier.

Option B (Employer Terminates Coverage) 088. According to an embodiment of the present invention, this option illustrates the impact of terminating coverage for all full-time employees. The penalty calculation 091 is based upon the total number of full-time employees entered in the Input Assumptions tab (all assumed to meet the definition of full-time employee working 30 hours or more per week under the Affordable Care Act) less the first 30 employees multiplied by the 4980H(a) applicable annual payment amount of $2,000. The lost tax shield is noted as a positive number that effectively increases the cost of the option 092.

As an illustrative example, the total employee count 094 is zero because the option terminates coverage for all employees. The number of subsidy-eligible employees 096, 099 is the count of those employees who are eligible for a premium tax credit as computed on the basis that their income is between 100% and 400% of the Federal Poverty Level for Non-Medicaid expansion states and between 0% and 400% of the Federal Poverty Level for Medicaid expansion states (0% to 133% for those automatically enrolled in Medicaid and 133% to 400% for premium tax credit eligible). The number of cost sharing reduction-eligible employees 096 is the count of those employees who are eligible for a premium tax credit as computed on the basis that their income is between 100% and 250% of the Federal Poverty Level. The subsidy-eligible counts 099 are graphically highlighted for each coverage tier with the count of the employees that meet the requirement calculated for each tier. The cost sharing reduction-eligible counts 100 are graphically highlighted for each coverage tier with the count of the employees that meet the requirement calculated for each tier.

Option C (Employer Adopts Hybrid Model) 088. According to an embodiment of the present invention, this option illustrates the cost for the employer providing employer-sponsored group coverage for all of its employees that are not eligible for premium tax credits and terminating coverage for those employees eligible for premium tax credits. The total cost of group coverage is the employer portion 090 and employee cost 095 for those employees not eligible for premium tax credits. The employer's cost is the amount of the total premium 090 it would contribute toward coverage for those covered under the employer-sponsored insurance coverage less the tax shield 092 resulting in the net cost. The total employee count 094 is the number of full-time and part-time employees from the Input Assumptions tab less the number of subsidy-eligible employees. The cost for the employees 097 is based upon the difference between the employer's contribution and the total cost of coverage for those not subsidy eligible. Each coverage tier 98 is graphically highlighted and the effective dollar contribution is calculated by aggregating all employee contributions and dividing this amount by the total number of employees that are not subsidy eligible that have coverage within their respective coverage tier.

As an illustrative example, the penalty calculation 091 is based upon the number of full-time only employees that are subsidy eligible multiplied by the 4980H(b) assessable payment amount of $3,000. The model assumes the employer is self-funded, offers minimum essential coverage (MEC) to all of its full-time employees on a nondiscriminatory basis ((§105(h)(2) of the Internal Revenue Code), and uses the lowest-cost self-only coverage as the basis for setting the target dollar employee-only contribution amount wherein each of the targeted full-time subsidy-eligible employee's contributions would exceed the minimum affordability threshold of 9.5% of self-only coverage. The target could be all subsidy-eligible, subsidy- and cost sharing-eligible, or only those employees at or below a certain Federal Poverty Level threshold (e.g., 275%). This contribution structure may result in a 50% employee-only contribution toward the lowest-cost self-only coverage, but only 20% of the highest of the highest-cost self-only coverage. The illustrated impact is that all targeted employees elect to go into the Exchange where they would receive premium tax credits and potential cost sharing-reduction subsidies, but are not covered by the employer's group plan. The result illustrated in Option C is that the employer expects to pay the lesser of the 4980H(b) assessable payment amount of $3,000 for each full-time employee that receives a premium tax credit (illustrated as 100% of those subsidy eligible) or the amount of the assessable payment that would have been imposed under section 4980H(a) if the employer failed to offer coverage to its full-time employees (and their dependents). The lost tax shield reduces the employer-sponsored insurance coverage tax shield and the result is the net tax shield 092.

As an illustrative example, the total employee count 094 is based upon those covered by employer-sponsored insurance coverage, as this option terminates coverage only for those subsidy-eligible employees. The number of subsidy-eligible employees 101 is the count of those employees who are eligible for a premium tax credit as computed on the basis that their income is between 100% and 400% of the Federal Poverty Level for Non-Medicaid expansion states and between 0% and 400% of the Federal Poverty Level for Medicaid expansion states (0% to 133% for those automatically enrolled in Medicaid and 133% to 400% for premium tax credit eligible). The subsidy-eligible counts are graphically highlighted 101 for each coverage tier with the count of the employees that meet the requirement calculated for each tier.

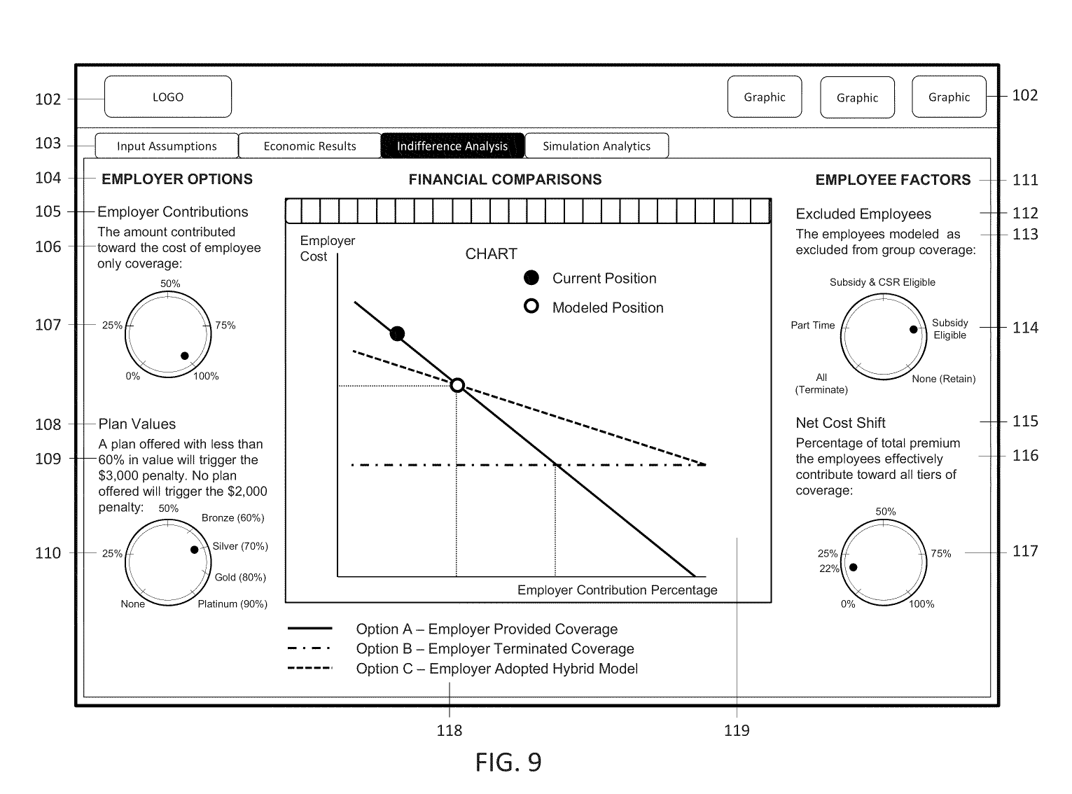

According to an embodiment of the present invention, the HDQM Lite will have an Indifference Analysis Tab. According to an embodiment of the present invention, this tab (FIG. 9) provides for a custom user logo and graphics 102 and other clickable tab headings 103. In a preferred embodiment, the process is constructed to provide the use of four input factors where the answers provide the basis for modeled results calculations that are then plotted on one of the three cost curves used to illustrate the financial comparison among the three options—Option A (Employer Provides Coverage), Option B (Employer Terminates Coverage), and Option C (Employer Adopts Hybrid Model).

According to an embodiment of the present invention, the two categories are Employer Options 104 and Employee Factors 111. In a preferred embodiment, the four input factors consist of employer contributions 105 (the amount contributed toward the cost of employee-only coverage 106), plan values 108 (the percentage of the total plan cost that is paid by the employer 109), excluded employees 112 (those employees to be excluded from coverage 113), and net cost shift 115 (the percentage of the total premium the employees will contribute toward all tiers of coverage 116). In the preferred embodiment, each of these input factors has a dialer that can be used to select percentages (employer contributions 107, plan values 110, and net cost shift 117) and employee segments (excluded employees 114).

According to an embodiment of the present invention, the three options 118 are Option A (Employer Provides Coverage), Option B (Employer Terminates Coverage), and Option C (Employer Adopts Hybrid Model) as described in the Modeled Results tab section. In a preferred embodiment, a graph 119 is shown with the three cost curves with the y-axis being the cost to the employer in dollars and x-axis, the percentage of the total cost to the employer. Option A illustrates the downward sloping cost curve. As the percentage of the employer contribution to the total premium decreases, the actual employer dollar contribution decreases. Option B is plotted as a horizontal straight line representing the fixed cost associated with 100% termination of employer-sponsored coverage. Option C is a combination of the downward sloping cost curve for those individuals covered under the employer-sponsored coverage and the horizontal fixed-cost straight line for those employees that are subsidy eligible. The graph captures the fact that the total penalty payment with the lost tax shield would never be greater than the total cost for Option B.

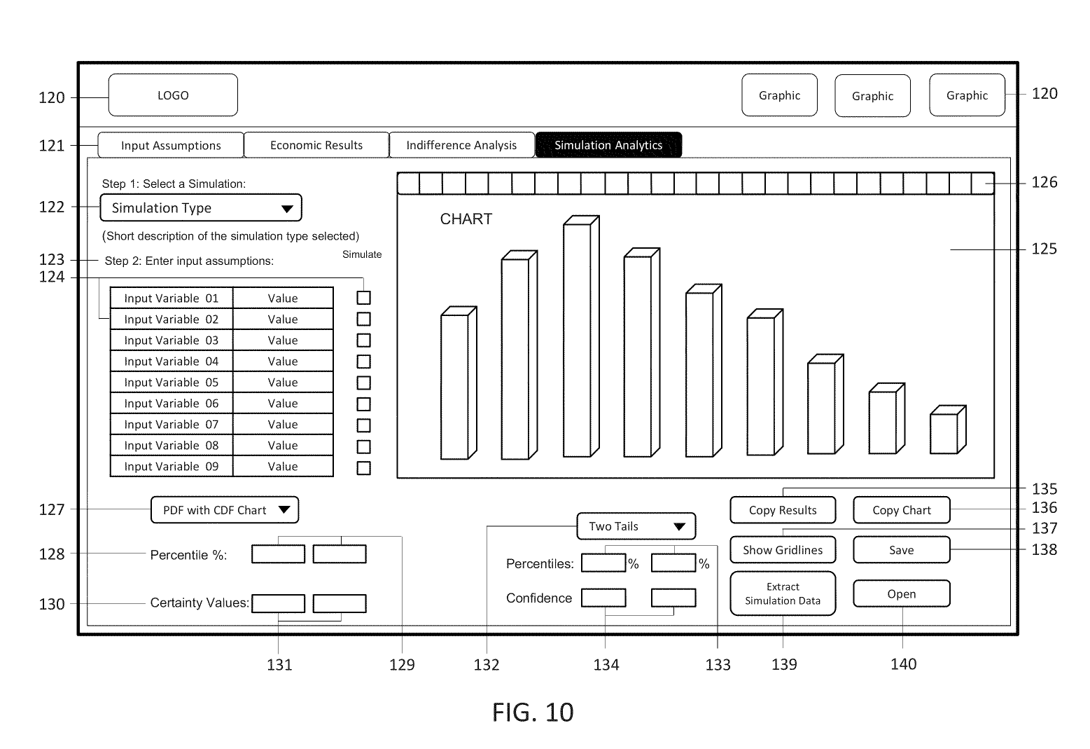

According to an embodiment of the present invention, the HDQM Lite will have a Simulation Analytics Tab. According to an embodiment of the present invention, this tab (FIG. 10) provides for a custom user logo and graphics 120 and other clickable tab headings 121. In a preferred embodiment, the process is designed to use Monte Carlo risk simulation to improve the confidence level of the user by illustrating a larger universe of representative employers with a random mix of possible employee combinations and their financial results. In the preferred embodiment, the process begins by selecting the type of simulation 122 from the drop-down list that is populated with various types of distributions (i.e., Exponential, Normal, Lognormal, Poisson, Triangular, Uniform, etc.). The next step is to select the input assumptions 123 with their respective values and check which of these input assumptions to simulate 124. Then the distributional chart results are illustrated 125. Simulation results charts can be modified using chart icons 126 and the chart types 127 can be changed and selected (e.g., histogram, nonlinear probability curves, cumulative distribution S-curves, area charts, bar charts, etc.). In the preferred embodiment, users can also enter percentiles (%) 128 in the input boxes 129 or certainty values ($) 130 in the relevant input boxes 131 and these lines will be shown in the chart. In an alternate preferred embodiment, a selection of various distribution tails (e.g., two tail, <left tail, right tail, etc.) 132 is made with the certainty confidence amounts entered 134 and the corresponding percentage confidence interval will be computed 133, or the desired percentage confidence interval is entered 133 and the corresponding certainty confidence amount will be calculated 134. Users can copy the statistical results 135 and charts 136, show gridlines 137 in the chart, save 138 the chart data, extract the simulated data 139, or open a previously saved simulation chart 140.

Employer Tax Shift

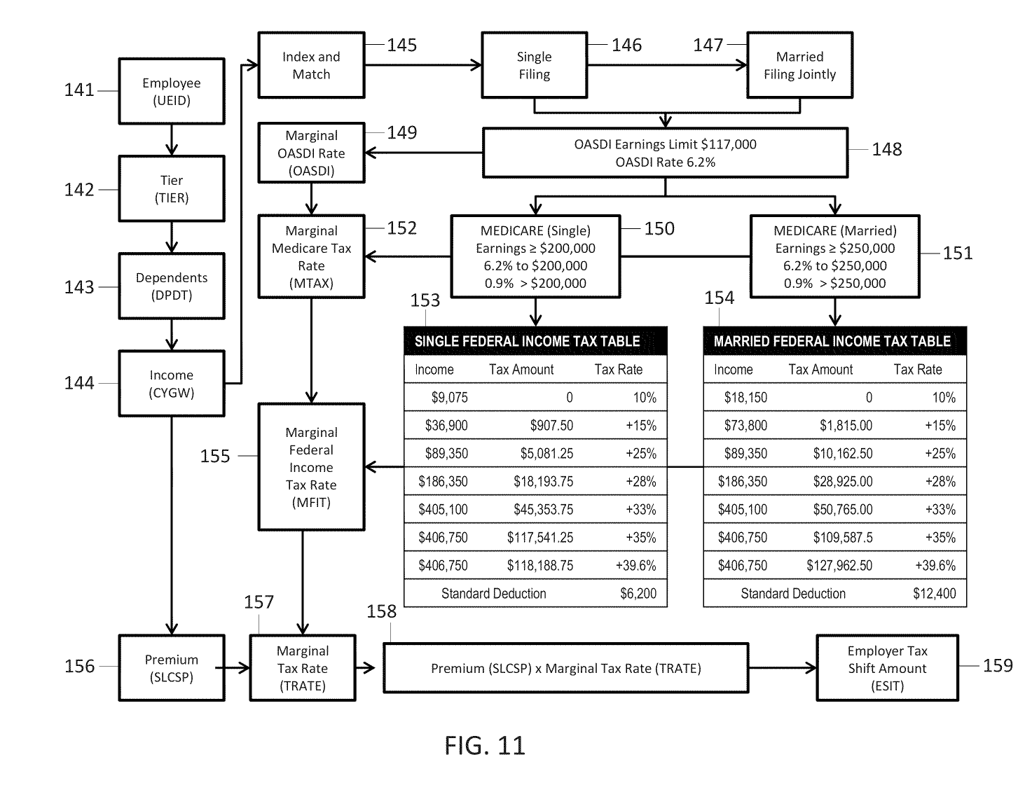

According to an embodiment of the present invention, the Employer Tax Shift is a radio button selection within the Options Variables group that calculates the impact of the additional income taxes an employee is estimated to incur as a direct result of the termination of employer-sponsored health insurance coverage. Before the termination of coverage, the employer's contribution toward the cost of an employee's health-care coverage was excluded from the gross income of the employee under §106 of the Internal Revenue Code. FIG. 11 illustrates an example of how the algorithm processes the calculation. In a preferred embodiment, the process begins with identifying the employee 141, determining the tier of coverage 142, the number of dependents 143, income 144, and after-tax premium payable by the employee 156. In the preferred embodiment, the indexing and matching function 145 determines whether the employee is a single 146 or a family 147 taxpayer. The income then goes through the algorithm to determine their OASDI tax 148, Medicare tax for single 150 or family 151, and the federal income tax calculation for single 153 or family 154. The marginal rates are determined for OASDI 149, Medicare 152, and federal income tax 155. These rates are combined into a marginal tax rate 157 that is then applied to the after-tax premium payable by the employee 158 to determine the Employer Tax Shift Amount 159.

Expand Income

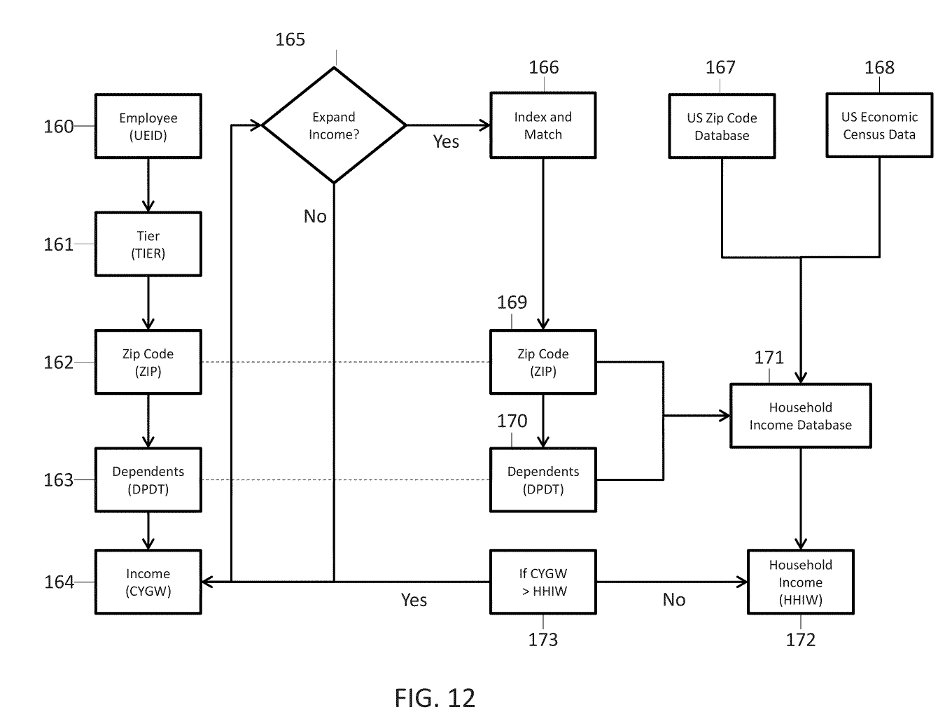

According to an embodiment of the present invention, the Expand Income is a radio button selection within the Options Variables group that allows the user to expand the income of the employee to the greater of their reported income or an estimate of household income data based upon the number of dependents and where they reside in the country sourcing U.S. economic census data. FIG. 12 illustrates an example of how the algorithm processes the calculation. In a preferred embodiment, the process begins with identifying the employee 160, determining the tier of coverage 161, the zip code of their residence 162, the number of dependents 163, and income 164. Next, selecting “No” to the expand income radio button 165 and use the current calendar year gross wages 164 uploaded within the census data, while selecting “Yes” to the expand income radio button 165 and step into an indexing and matching process 166 that takes the zip code 169 and the number of dependents 170 and matches them within the household income data base that has been constructed 171 through the combination of the U.S. zip code data base 167 and U.S. economic census data 168. In the preferred embodiment, a calculation is generated 173 that determines if the calendar year gross wage is greater than the sourced household income data. If the result is “yes,” calendar year gross wages are used 164. If the result is “no,” household income data are used 172.

Expand Tax Credits

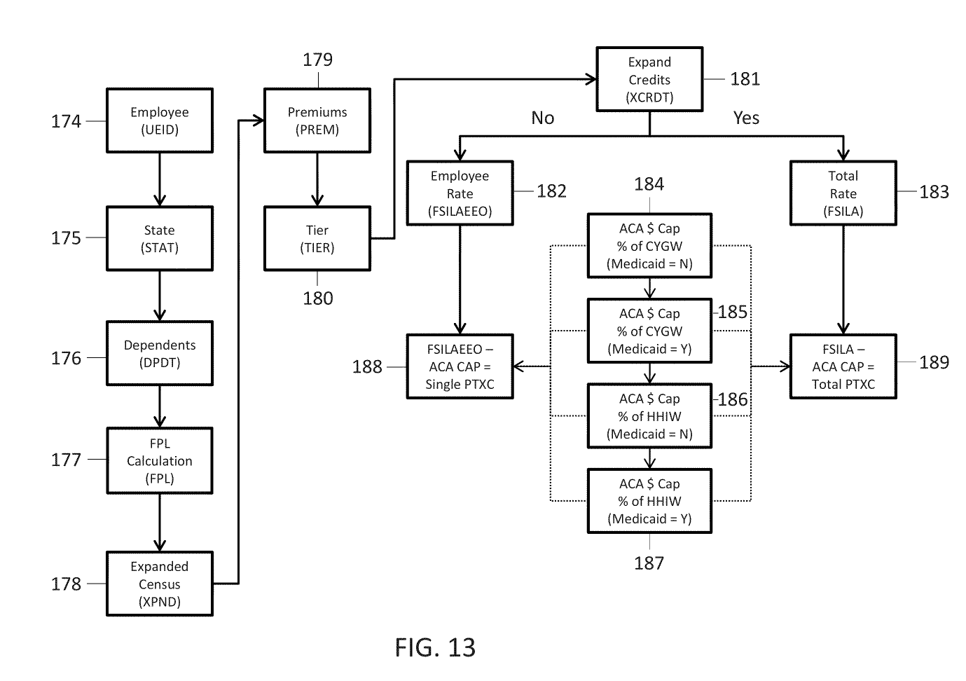

According to an embodiment of the present invention, the Expand Tax Credits is a radio button selection within the Options Variables group that allows the user to expand the basis for the premium tax credit determination to that of the family based upon the number of dependents loaded within the census data or to keep it at employee only. FIG. 13 illustrates an example of how the algorithm processes the calculation. In a preferred embodiment, the process begins with identifying the employee 174, determining the state of residence 175, the number of dependents 176, the Federal Poverty Level calculation 177, the expanded census status 178 for premium determination, the premium calculations 179, and the coverage tier 180. In the preferred embodiment, integrated into these premium tax credit calculations is the determination whether the income basis is calendar gross wages in a non-Medicaid expansion state 184, the income basis is calendar gross wages in a Medicaid expansion state 185, the income basis is household income substitution in a non-Medicaid expansion state 186, or the income basis is household income substitution in a Medicaid expansion state 187. In the preferred embodiment, a “No” decision to expand premium tax credits 181 sources the employee only rate 182 and performs the appropriate premium tax credit calculation 188, while a “Yes” decision to expand premium tax credits sources the total rate 183 (which is the range from single to family based upon their coverage tier) and performs the appropriate premium tax credit calculation 189.

Allocation

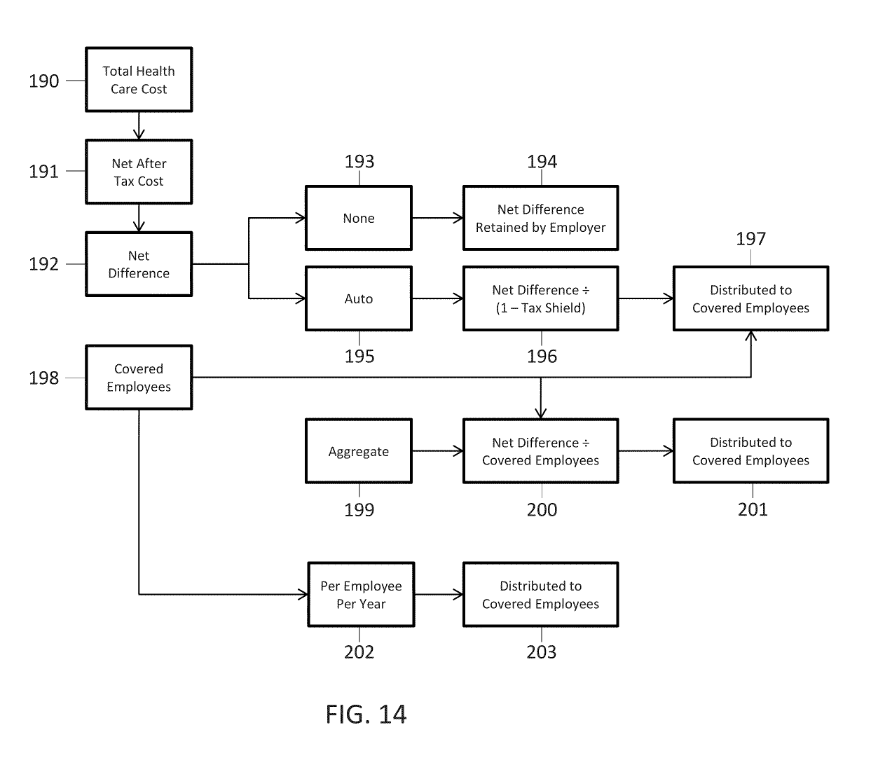

According to an embodiment of the present invention, Allocation is a functionality that is located within the Options Variables section of the utility that consists of four methods of distributing savings if savings are generated as a result of the option (FIG. 14). In a preferred embodiment, these four methods are selected from a drop-down list where the amount is populated from the results calculations (auto) or manually entered (aggregate and per employee). In the preferred embodiment, the process begins with sourcing the current total health-care costs 190, determining the current net after tax cost 191, calculating the net difference between the current net after tax cost and the option cost 192, and sourcing the covered employees 198 to be used as the basis for any distribution. In the preferred embodiment, different selections are available. For example: If “None” is selected 193, the net difference is retained by the employer 194 as savings resulting from the change to the option. If “Auto” is selected 195, the net difference is adjusted to reflect that tax shield for distributing this higher amount 196 that integrates the tax shield for the deductibility of the distribution to the covered employees 197 that makes the option result equal to the current net after tax cost. If “Aggregate” is selected 199, the amount selected by the user is divided across the covered employees 200 and distributed as a flat dollar amount to each covered employee 201. If “Per Employee” is selected 202, the user defines a per-employee annual amount that is distributed 203 to the covered employees.

Description of Global Application and Contingencies

The present invention applies to the domestic health-care marketplace in the United States with potential extraterritorial applications across national and international boundaries. Other countries have looked to the United States as a leader in health-care innovation and have adopted many of the inventions with respect to health-care infrastructure and financing. An example of such an adoption is that of the diagnosis-related groups, or DRGs. In the early 1960s researchers at Yale University developed DRGs as a reimbursement methodology that aligned a hospital's workload to its costs, at an individual level (case-by-case) and by hospital (global level). In 1983 Medicare adopted the DRG-based scheme as a part of a prospective payment system for hospital inpatient treatments. In the mid-1980s commercial health plans in the United States adopted the DRG methodology as part of their provider contracting payment system for inpatient services with hospitals. In 1992 Australia, in 2002 Germany, and in 2008 Switzerland each adopted a DRG-based system. The present invention is designed for comparable adoption, adaptation, and customization across borders. In fact, the model adopted in the U.S. is a derivative of an exchange-based model used in Switzerland where all of the residents of Switzerland must have coverage and exchange mechanisms are in place to facilitate the purchase of coverage.

Notwithstanding all of the legislative, judicial, and executive friction that has been occurring since the initial passage of the Affordable Care Act, this present invention was designed to pivot and accommodate for the contingencies that may emerge as a result of adverse consequences. For example, we are monitoring to see whether there are changes to the legislation on the horizon: elimination of the individual mandate, failure of the state-based exchanges, abolition of premium tax credits, rejection and deferral of employer-based premium tax penalties, dismissal and deferral of expanded eligibility requirements, repeal of the medical loss ratio requirements, reversal of the essential health benefits coverage requirement, and the elimination of employer-sponsored insurance tax subsidization of coverage to employees under §106 of the Internal Revenue Code. We are observing to see if there is a real chance of any repeal of the existing legislation, the development and acceptance of privately run health insurance exchanges, the growth of defined contribution health plans, the elimination of statutory cross-border insurance barriers to entry, abolition of the tax-favored status of employer-based health insurance, and the detachment of employment-based insurance coverage. The present invention has no impact on simulation, optimization, cohort analysis, and time-series forecasting. Where it does have impact is in the area of real options analysis. However, the present invention is capable of accepting the tweaks and modifications necessary to never be in peril of obsolescence as discussed below.

Real options are not limited to the compulsory requirements driven by legislative action, but may emerge as a result of enabling legislation and coexist within a whole portfolio of possibilities. For example, adopting a defined health-care contribution approach is an option that may be considered a solution that is independent of health reform legislation where a corporation may decide to set a contribution amount and shift the purchasing decision of health-care coverage to the employee for purchase in the open market. Another example is a decision by a corporation to sponsor a high-deductible health plan where it elects to either fund or not fund health savings accounts. A third example is an option resulting from the enabling health reform legislation where the corporation may elect to terminate employer-sponsored coverage and pay a penalty.

The development of the health insurance exchanges in each of the individual states as required by the health-care legislation was conceived to provide individuals and small businesses an opportunity to purchase health care with group buying power. The federal government also has a role in that if a state decides not to build an exchange, the federal government will step in to perform this function, and that the Office of Personnel Management (OPM) must provide two multistate qualified health plan options in each individual state's insurance exchange. In the event that this legislation is repealed, the legislation is defunded, or agencies are directed to cease and desist with guideline issuance, the state-run exchange development will fail. The implications are broad in that the market, as it exists today, would be virtually unchanged and the advent of premium tax credits and cost-sharing subsidies would never take effect. Notwithstanding, private health insurance exchanges are continuing to gain traction and are emerging as a market alternative.

Mathematical Probability Distributions

This section demonstrates the mathematical models and computations used in creating the Monte Carlo risk-based simulations as described throughout the current invention. In order to get started with simulation, one first needs to understand the concept of probability distributions. To begin to understand probability, consider this example: You want to look at the distribution of nonexempt wages within one department of a large company. First, you gather raw data—in this case, the wages of each nonexempt employee in the department. Second, you organize the data into a meaningful format and plot the data as a frequency distribution on a chart. To create a frequency distribution, you divide the wages into group intervals and list these intervals on the chart's horizontal axis. Then you list the number or frequency of employees in each interval on the chart's vertical axis. Now you can easily see the distribution of nonexempt wages within the department. You can chart this data as a probability distribution. A probability distribution shows the number of employees in each interval as a fraction of the total number of employees. To create a probability distribution, you divide the number of employees in each interval by the total number of employees and list the results on the chart's vertical axis.

Probability distributions are either discrete or continuous. Discrete probability distributions describe distinct values, usually integers, with no intermediate values and are shown as a series of vertical bars. A discrete distribution, for example, might describe the number of heads in four flips of a coin as 0, 1, 2, 3, or 4. Continuous probability distributions are actually mathematical abstractions because they assume the existence of every possible intermediate value between two numbers; that is, a continuous distribution assumes there is an infinite number of values between any two points in the distribution. However, in many situations, you can effectively use a continuous distribution to approximate a discrete distribution even though the continuous model does not necessarily describe the situation exactly.

Probability Density Functions, Cumulative Distribution Functions, and Probability Mass Functions

In mathematics and Monte Carlo simulation, a probability density function (PDF) represents a continuous probability distribution in terms of integrals. If a probability distribution has a density of ƒ(x), then intuitively the infinitesimal interval of [x, x+dx] has a probability of ƒ(x) dx. The PDF therefore can be seen as a smoothed version of a probability histogram; that is, by providing an empirically large sample of a continuous random variable repeatedly, the histogram using very narrow ranges will resemble the random variable's PDF. The probability of the interval between [a, b] is given by

$${\int }_{a}^{b} f ( x ) d x ,$$

which means that the total integral of the function ƒ must be 1.0. It is a common mistake to think of ƒ(a) as the probability of a. This is incorrect. In fact, ƒ(a) can sometimes be larger than 1—consider a uniform distribution between 0.0 and 0.5. The random variable x within this distribution will have ƒ(x) greater than 1. The probability in reality is the function ƒ(x)dx discussed previously, where dx is an infinitesimal amount.

The cumulative distribution function (CDF) is denoted as F(x)=P(X≦x) indicating the probability of X taking on a less than or equal value to x. Every CDF is monotonically increasing, is continuous from the right, and at the limits, have the following properties:

$$F ( b ) - F ( a ) = P ( a \leq X \leq b ) = {\int }_{a}^{b} f ( x ) d x ,$$

Further, the CDF is related to the PDF by

$${lim}_{x -> - ∞} F ( x ) = 0 and {lim}_{x -> + ∞} F ( x ) = 1.$$

where the PDF function ƒ is the derivative of the CDF function F.

In probability theory, a probability mass function or PMF gives the probability that a discrete random variable is exactly equal to some value. The PMF differs from the PDF in that the values of the latter, defined only for continuous random variables, are not probabilities; rather, its integral over a set of possible values of the random variable is a probability. A random variable is discrete if its probability distribution is discrete and can be characterized by a PMF. Therefore, X is a discrete random variable if

$${\sum }_{u} P ( X = u ) = 1$$

as u runs through all possible values of the random variable X.

Discrete Distributions

Following is a detailed listing of the different types of probability distributions that can be used in Monte Carlo simulation.

Bernoulli or Yes/No Distribution

The Bernoulli distribution is a discrete distribution with two outcomes (e.g., head or tails, success or failure, 0 or 1). The Bernoulli distribution is the binomial distribution with one trial and can be used to simulate Yes/No or Success/Failure conditions. This distribution is the fundamental building block of other more complex distributions. For instance:
Binomial distribution: Bernoulli distribution with higher number of n total trials and computes the probability of x successes within this total number of trials.
Geometric distribution: Bernoulli distribution with higher number of trials and computes the number of failures required before the first success occurs.
Negative binomial distribution: Bernoulli distribution with higher number of trials and computes the number of failures before the xth success occurs.

The mathematical constructs for the Bernoulli distribution are as follows:

$$P ( x ) = \{ \begin{matrix}1 - p & for x = 0 \\ p & for x = 1\end{matrix} \\ or \\ P ( x ) = {{p}^{x} ( 1 - p )}^{1 - x} \\ mean = p \\ standard deviation = \sqrt{p ( 1 - p )} \\ skewness = \frac{1 - 2 p}{\sqrt{p ( 1 - p )}} \\ excess kurtosis = \frac{6 {p}^{2} - 6 p + 1}{p ( 1 - p )} \qquad$$

The probability of success (p) is the only distributional parameter. Also, it is important to note that there is only one trial in the Bernoulli distribution, and the resulting simulated value is either 0 or 1. The input requirements are such that Probability of Success >0 and <1 (that is, 0.0001≦p≦0.9999).

Binomial Distribution

The binomial distribution describes the number of times a particular event occurs in a fixed number of trials, such as the number of heads in 10 flips of a coin or the number of defective items out of 50 items chosen. The three conditions underlying the binomial distribution are:
For each trial, only two outcomes are possible that are mutually exclusive.
The trials are independent—what happens in the first trial does not affect the next trial.
The probability of an event occurring remains the same from trial to trial.

The mathematical constructs for the binomial distribution are as follows:

$$P ( x ) = \frac{n !}{x ! ( n - x ) !} {{p}^{x} ( 1 - p )}^{( n - x )}$$

$$for n > 0 ; x = 0 , 1 , 2 , … n ; and 0 < p < 1$$

$$mean = np$$

$$standard deviation = \sqrt{np ( 1 - p )}$$

$$skewness = \frac{1 - 2 p}{\sqrt{np ( 1 - p )}}$$

$$excess kurtosis = \frac{6 {p}^{2} - 6 p + 1}{np ( 1 - p )}$$

The probability of success (p) and the integer number of total trials (n) are the distributional parameters. The number of successful trials is denoted x. It is important to note that probability of success (p) of 0 or 1 are trivial conditions and do not require any simulations, and hence, are not allowed in the software. The input requirements are such that Probability of Success >0 and <1 (that is, 0.0001≦p≦0.9999), the Number of Trials ≧1 or positive integers and ≦1000 (for larger trials, use the normal distribution with the relevant computed binomial mean and standard deviation as the normal distribution's parameters).

Discrete Uniform

The discrete uniform distribution is also known as the equally likely outcomes distribution, where the distribution has a set of N elements, and each element has the same probability. This distribution is related to the uniform distribution but its elements are discrete and not continuous.

The mathematical constructs for the discrete uniform distribution are as follows:

$$P ( x ) = \frac{1}{N}$$

$$mean = \frac{N + 1}{2} ranked value$$

$$standard deviation = \sqrt{\frac{( N - 1 ) ( N + 1 )}{12}} ranked value$$

$$skewness = 0 ( that is , the distribution is perfectly symmetrical )$$

$$excess kurtosis = \frac{- 6 ( {N}^{2} + 1 )}{5 ( N - 1 ) ( N + 1 )} ranked value$$

The input requirements are such that Minimum<Maximum and both must be integers (negative integers and zero are allowed).

Geometric Distribution

The geometric distribution describes the number of trials until the first successful occurrence, such as the number of times you need to spin a roulette wheel before you win. The three conditions underlying the geometric distribution are:
The number of trials is not fixed.
The trials continue until the first success.
The probability of success is the same from trial to trial.

The mathematical constructs for the geometric distribution are as follows:

$$P ( x ) = {p ( 1 - p )}^{x - 1} for 0 < p < 1 and x = 1 , 2 , … , n$$

$$mean = \frac{1}{p} - 1$$

$$standard deviation = \sqrt{\frac{1 - p}{{p}^{2}}}$$

$$skewness = \frac{2 - p}{\sqrt{1 - p}}$$

$$excess kurtosis = \frac{{p}^{2} - 6 p + 6}{1 - p}$$

The probability of success (p) is the only distributional parameter. The number of successful trials simulated is denoted x, which can only take on positive integers. The input requirements are such that Probability of success >0 and <1 (that is, 0.0001≦p≦0.9999). It is important to note that probability of success (p) of 0 or 1 are trivial conditions and do not require any simulations, and hence, are not allowed in the software.

Hypergeometric Distribution

The hypergeometric distribution is similar to the binomial distribution in that both describe the number of times a particular event occurs in a fixed number of trials. The difference is that binomial distribution trials are independent, whereas hypergeometric distribution trials change the probability for each subsequent trial and are called trials without replacement. For example, suppose a box of manufactured parts is known to contain some defective parts. You choose a part from the box, find it is defective, and remove the part from the box. If you choose another part from the box, the probability that it is defective is somewhat lower than for the first part because you have removed a defective part. If you had replaced the defective part, the probabilities would have remained the same, and the process would have satisfied the conditions for a binomial distribution. The three conditions underlying the hypergeometric distribution are:
The total number of items or elements (the population size) is a fixed number, a finite population. The population size must be less than or equal to 1,750.
The sample size (the number of trials) represents a portion of the population.
The known initial probability of success in the population changes after each trial.

The mathematical constructs for the hypergeometric distribution are as follows:

$$P ( x ) = \frac{\frac{( {N}_{x} ) !}{x ! ( {N}_{x} - x ) !} \frac{( N - {N}_{x} ) !}{( n - x ) ! ( N - {N}_{x} - n + x ) !}}{\frac{N !}{n ! ( N - n ) !}}$$

$$for x = Max ( n - ( N - {N}_{x} ) , 0 ) , … , Min ( n , {N}_{x} )$$

$$mean = \frac{{N}_{x} n}{N}$$

$$standard deviation = \sqrt{\frac{( N - {N}_{x} ) {N}_{x} n ( N - n )}{{N}^{2} ( N - 1 )}}$$

$$skewness = \frac{( N - 2 {N}_{x} ) ( N - 2 x )}{N - 2} \sqrt{\frac{N - 1}{( N - {N}_{x} ) {N}_{x} n ( N - n )}}$$

$$excess kurtosis = \frac{V ( N , {N}_{x} , n )}{( N - {N}_{x} ) {N}_{x} n ( - 3 + N ) ( - 2 + N ) ( - N + n )} where$$

$$V ( N , {N}_{x} , n ) = {( N - {N}_{x} )}^{3} - {( N - {N}_{x} )}^{5} + 3 {( N - {N}_{x} )}^{2} {N}_{x} - 6 {( N - {N}_{x} )}^{3} {N}_{x} + {( N - {N}_{x} )}^{4} {N}_{x} + 3 ( N - {N}_{x} ) {N}_{x}^{2} - 12 {( N - {N}_{x} )}^{2} {N}_{x}^{2} + 8 {( N - {N}_{x} )}^{3} {N}_{x}^{2} + {N}_{x}^{3} - 6 ( N - {N}_{x} ) {N}_{x}^{3} + 8 {( N - {N}_{x} )}^{2} {N}_{x}^{3} + ( N - {N}_{x} ) {N}_{x}^{4} - {N}_{x}^{5} - 6 {( N - {N}_{x} )}^{3} {N}_{x} + 6 {( N - {N}_{x} )}^{4} {N}_{x} + 18 {( N - {N}_{x} )}^{2} {N}_{x} n - 6 {( N - {N}_{x} )}^{3} {N}_{x} n + 18 ( N - {N}_{x} ) {N}_{x}^{2} n - 24 {( N - {N}_{x} )}^{2} {N}_{x}^{2} n - {( N - {N}_{x} )}^{3} n - 6 ( N - {N}_{x} ) {N}_{x}^{3} + 6 {N}_{x}^{4} n + 6 {( N - {N}_{x} )}^{2} {n}^{2} - 6 {( N - {N}_{x} )}^{3} {n}^{2} - 24 ( N - {N}_{x} ) {N}_{x} {n}^{2} + 12 {( N - {N}_{x} )}^{2} {N}_{x} {n}^{2} + 6 {N}_{x}^{2} {n}^{2} + 12 ( N - {N}_{x} ) {N}_{x}^{2} {n}^{2} - 6 {N}_{x}^{3} {n}^{2}$$

The number of items in the population (N), trials sampled (n), and number of items in the population that have the successful trait (Nₓ) are the distributional parameters. The number of successful trials is denoted x. The input requirements are such that Population >2 and integer, Trials >0 and integer, Successes >0 and integer, Population >Successes, Trials <Population, and Population <1750.

Negative Binomial Distribution

The negative binomial distribution is useful for modeling the distribution of the number of trials until the rth successful occurrence, such as the number of sales calls you need to make to close a total of 10 orders. It is essentially a superdistribution of the geometric distribution. This distribution shows the probabilities of each number of trials in excess of r to produce the required success r. The three conditions underlying the negative binomial distribution are:
The number of trials is not fixed.
The trials continue until the rth success.
The probability of success is the same from trial to trial.

The mathematical constructs for the negative binomial distribution are as follows:

$$P ( x ) = \frac{( x + r - 1 ) !}{( r - 1 ) ! x !} {{p}^{r} ( 1 - p )}^{x}$$

$$for x = r , r + 1 , … ; and 0 < p < 1$$

$$mean = \frac{r ( 1 - p )}{p}$$

$$standard deviation = \sqrt{\frac{r ( 1 - p )}{{p}^{2}}}$$

$$skewness = \frac{2 - p}{\sqrt{r ( 1 - p )}}$$

$$excess kurtosis = \frac{{p}^{2} - 6 p + 6}{r ( 1 - p )}$$

Probability of success (p) and required successes (r) are the distributional parameters. Where the input requirements are such that Successes required must be positive integers >0 and <8000, Probability of success >0 and <1 (that is, 0.0001≦p≦0.9999). It is important to note that probability of success (p) of 0 or 1 are trivial conditions and do not require any simulations, and hence, are not allowed in the software.

Poisson Distribution

The Poisson distribution describes the number of times an event occurs in a given interval, such as the number of telephone calls per minute or the number of errors per page in a document. The three conditions underlying the Poisson distribution are:
The number of possible occurrences in any interval is unlimited.
The occurrences are independent. The number of occurrences in one interval does not affect the number of occurrences in other intervals.
The average number of occurrences must remain the same from interval to interval.

The mathematical constructs for the Poisson are as follows:

$$P ( x ) = \frac{{e}^{- λ} {λ}^{x}}{x !} for x and λ > 0$$

$$mean = λ$$

$$standard deviation = \sqrt{λ}$$

$$skewness = \frac{1}{\sqrt{λ}}$$

$$excess kurtosis = \frac{1}{λ}$$

Rate (λ) is the only distributional parameter and the input requirements are such that Rate >0 and ≦1000 (that is, 0.0001≦rate≦1000).

Continuous Distributions

Beta Distribution.

The beta distribution is very flexible and is commonly used to represent variability over a fixed range. One of the more important applications of the beta distribution is its use as a conjugate distribution for the parameter of a Bernoulli distribution. In this application, the beta distribution is used to represent the uncertainty in the probability of occurrence of an event. It is also used to describe empirical data and predict the random behavior of percentages and fractions, as the range of outcomes is typically between 0 and 1. The value of the beta distribution lies in the wide variety of shapes it can assume when you vary the two parameters, alpha and beta. If the parameters are equal, the distribution is symmetrical. If either parameter is 1 and the other parameter is greater than 1, the distribution is J-shaped. If alpha is less than beta, the distribution is said to be positively skewed (most of the values are near the minimum value). If alpha is greater than beta, the distribution is negatively skewed (most of the values are near the maximum value). The mathematical constructs for the beta distribution are as follows:

$$f ( x ) = \frac{{( x )}^{( α - 1 )} {( 1 - x )}^{( β - 1 )}}{[ \frac{Γ ( α ) Γ ( β )}{Γ ( α + β )} ]} for α > 0 ; β > 0 ; x > 0$$

$$mean = \frac{α}{α + β}$$

$$standard deviation = \sqrt{\frac{α β}{{( α + β )}^{2} ( 1 + α + β )}}$$

$$skewness = \frac{2 ( β - α ) \sqrt{1 + α + β}}{( 2 + α + β ) \sqrt{α β}}$$

$$excess kurtosis = \frac{3 ( α + β + 1 ) [ α β ( α + β - 6 ) + 2 {( α + β )}^{2} ]}{α β ( α + β + 2 ) ( α + β + 3 )} - 3$$

Alpha (α) and beta (β) are the two distributional shape parameters, and Γ is the gamma function. The two conditions underlying the beta distribution are:
The uncertain variable is a random value between 0 and a positive value.
The shape of the distribution can be specified using two positive values.

Input requirements: Alpha and beta >0 and can be any positive value

Cauchy Distribution or Lorentzian Distribution or Breit-Wigner Distribution

The Cauchy distribution, also called the Lorentzian distribution or Breit-Wigner distribution, is a continuous distribution describing resonance behavior. It also describes the distribution of horizontal distances at which a line segment tilted at a random angle cuts the x-axis.

The mathematical constructs for the cauchy or Lorentzian distribution are as follows:

$$f ( x ) = \frac{1}{π} \frac{γ / 2}{{( x - m )}^{2} + {γ}^{2} / 4}$$

The cauchy distribution is a special case where it does not have any theoretical moments (mean, standard deviation, skewness, and kurtosis) as they are all undefined. Mode location (m) and scale (γ) are the only two parameters in this distribution. The location parameter specifies the peak or mode of the distribution while the scale parameter specifies the half-width at half-maximum of the distribution. In addition, the mean and variance of a cauchy or Lorentzian distribution are undefined. In addition, the cauchy distribution is the Student's t distribution with only 1 degree of freedom. This distribution is also constructed by taking the ratio of two standard normal distributions (normal distributions with a mean of zero and a variance of one) that are independent of one another. The input requirements are such that Location can be any value whereas Scale >0 and can be any positive value.

Chi-Square Distribution

The chi-square distribution is a probability distribution used predominatly in hypothesis testing, and is related to the gamma distribution and the standard normal distribution. For instance, the sums of independent normal distributions are distributed as a chi-square (χ²) with k degrees of freedom:

Z₁²+Z₂²+ . . . +Zₖ²^{^{d}}·χₖ²

The mathematical constructs for the chi-square distribution are as follows:

$$f ( x ) = \frac{{2}^{- k / 2}}{Γ ( k / 2 )} {x}^{k / 2 - 1} {e}^{- x / 2} for all x > 0$$

$$mean = k$$

$$standard deviation = \sqrt{2 k}$$

$$skewness = 2 \sqrt{\frac{2}{k}}$$

$$excess kurtosis = \frac{12}{k}$$

Γ is the gamma function. Degrees of freedom k is the only distributional parameter. The chi-square distribution can also be modeled using a gamma distribution by setting the shape

$$parameter = \frac{k}{2} and scale = 2 {S}^{2}$$

where S is the scale. The input requirements are such that Degrees of freedom >1 and must be an integer <1000.

Exponential Distribution

The exponential distribution is widely used to describe events recurring at random points in time, such as the time between failures of electronic equipment or the time between arrivals at a service booth. It is related to the Poisson distribution, which describes the number of occurrences of an event in a given interval of time. An important characteristic of the exponential distribution is the “memoryless” property, which means that the future lifetime of a given object has the same distribution, regardless of the time it existed. In other words, time has no effect on future outcomes. The mathematical constructs for the exponential distribution are as follows:

$$f ( x ) = λ {e}^{- λ x} for x \geq 0 , λ > 0$$

$$mean = \frac{1}{λ}$$

$$standard deviation = \frac{1}{λ}$$

$$skewness = 2 ( this value applies to all success rate λ inputs )$$

$$excess kurtosis = 6 ( this value applies to all success rate λ inputs )$$

Success rate (λ) is the only distributional parameter. The number of successful trials is denoted x.

The condition underlying the exponential distribution is:
The exponential distribution describes the amount of time between occurrences. Input requirements: Rate >0 and ≦300

Extreme Value Distribution or Gumbel Distribution

The extreme value distribution (Type 1) is commonly used to describe the largest value of a response over a period of time, for example, in flood flows, rainfall, and earthquakes. Other applications include the breaking strengths of materials, construction design, and aircraft loads and tolerances. The extreme value distribution is also known as the Gumbel distribution.

The mathematical constructs for the extreme value distribution are as follows:

$$f ( x ) = \frac{1}{β} z {e}^{- Z} where z = {e}^{\frac{x - m}{β}}$$

$$for β > 0 ; and any value of x and m$$

$$mean = m + 0.577215 β$$

$$standard deviation = \sqrt{\frac{1}{6} {π}^{2} {β}^{2}}$$

$$skewness = \frac{12 \sqrt{6} ( 1.2020569 )}{{π}^{3}} = 1.13955 ( this applies for all values of mode and scale )$$

$$excess kurtosis = 5.4 ( this applies for all values of mode and scale )$$

Mode (m) and scale (β) are the distributional parameters. There are two standard parameters for the extreme value distribution: mode and scale. The mode parameter is the most likely value for the variable (the highest point on the probability distribution). The scale parameter is a number greater than 0. The larger the scale parameter, the greater the variance. The input requirements are such that Mode can be any value and Scale >0.

F Distribution or Fisher-Snedecor Distribution

The F distribution, also known as the Fisher-Snedecor distribution, is another continuous distribution used most frequently for hypothesis testing. Specifically, it is used to test the statistical difference between two variances in analysis of variance tests and likelihood ratio tests. The F distribution with the numerator degree of freedom n and denominator degree of freedom m is related to the chi-square distribution in that:

$$\frac{{χ}_{n}^{2} / n}{{χ}_{m}^{2} / m} {\sim}^{d} {F}_{n , m}$$

$$or f ( x ) = \frac{Γ ( \frac{n + m}{2 } ) {( \frac{n}{m} )}^{n / 2} {x}^{n / 2 - 1}}{Γ ( \frac{n}{2} ) {Γ ( \frac{m}{2} ) [ x ( \frac{n}{m} ) + 1 ]}^{( n + m ) / 2}}$$

$$mean = \frac{m}{m - 2}$$

$$standard deviation = \frac{2 {m}^{2} ( m + n - 2 )}{{n ( m - 2 )}^{2} ( m - 4 )} for all m > 4$$

$$skewness = \frac{2 ( m + 2 n - 2 )}{m - 6} \sqrt{\frac{2 ( m - 4 )}{n ( m + n - 2 )}}$$

$$excess kurtosis = \frac{12 ( - 16 + 20 m - 8 {m}^{2} + {m}^{3} + 44 n - 32 mn + 5 {m}^{2} n - 22 {n}^{2} + 5 {mn}^{2}}{n ( m - 6 ) ( m - 8 ) ( n + m - 2 )}$$

The numerator degree of freedom n and denominator degree of freedom m are the only distributional parameters. The input requirements are such that Degrees of freedom numerator and degrees of freedom denominator both >0 integers.

Gamma Distribution (Erlang Distribution)

The gamma distribution applies to a wide range of physical quantities and is related to other distributions: lognormal, exponential, Pascal, Erlang, Poisson, and Chi-Square. It is used in meteorological processes to represent pollutant concentrations and precipitation quantities. The gamma distribution is also used to measure the time between the occurrence of events when the event process is not completely random. Other applications of the gamma distribution include inventory control, economic theory, and insurance risk theory.

The gamma distribution is most often used as the distribution of the amount of time until the rth occurrence of an event in a Poisson process. When used in this fashion, the three conditions underlying the gamma distribution are:
The number of possible occurrences in any unit of measurement is not limited to a fixed number.
The occurrences are independent. The number of occurrences in one unit of measurement does not affect the number of occurrences in other units.
The average number of occurrences must remain the same from unit to unit.

The mathematical constructs for the gamma distribution are as follows:

$$f ( x ) = \frac{{( \frac{x}{β} )}^{α - 1} {e}^{- \frac{x}{β}}}{Γ ( α ) β} with any value of α > 0 and β > 0$$

$$mean = α β$$

$$standard deviation = \sqrt{α {β}^{2}}$$

$$skewness = \frac{2}{\sqrt{α}}$$

$$excess kurtosis = \frac{6}{α}$$

Shape parameter alpha (α) and scale parameter beta (β) are the distributional parameters, and Γ is the gamma function. When the alpha parameter is a positive integer, the gamma distribution is called the Erlang distribution, used to predict waiting times in queuing systems, where the Erlang distribution is the sum of independent and identically distributed random variables each having a memoryless exponential distribution. Setting n as the number of these random variables, the mathematical construct of the Erlang distribution is:

$$f ( x ) = \frac{{x}^{n - 1} {e}^{- x}}{( n - 1 ) !} for all x > 0 and all positive integers of n ,$$

where the input requirements are such that Scale Beta >0 and can be any positive value, Shape Alpha ≧0.05 and any positive value, and Location can be any value.

Logistic Distribution

The logistic distribution is commonly used to describe growth, that is, the size of a population expressed as a function of a time variable. It also can be used to describe chemical reactions and the course of growth for a population or individual.

The mathematical constructs for the logistic distribution are as follows:

$$f ( x ) = {e}^{\frac{μ - x}{α}} for any value of α and μ$$

$$mean = μ$$

$$standard deviation = \sqrt{\frac{1}{3} {π}^{2} {α}^{2}}$$

$$skewness = 0 ( this applies to all mean and scale inputs )$$

$$excess kurtosis = 1.2 ( this applies to all mean and scale inputs )$$

Mean (μ) and scale (α) are the distributional parameters. There are two standard parameters for the logistic distribution: mean and scale. The mean parameter is the average value, which for this distribution is the same as the mode, because this distribution is symmetrical. The scale parameter is a number greater than 0. The larger the scale parameter, the greater the variance. Input requirements: Scale >0 and can be any positive value and Mean can be any value.

Lognormal Distribution

The lognormal distribution is widely used in situations where values are positively skewed, for example, in financial analysis for security valuation or in real estate for property valuation, and where values cannot fall below zero. Stock prices are usually positively skewed rather than normally (symmetrically) distributed. Stock prices exhibit this trend because they cannot fall below the lower limit of zero but might increase to any price without limit. Similarly, real estate prices illustrate positive skewness and are lognormally distributed as property values cannot become negative. The three conditions underlying the lognormal distribution are:
The uncertain variable can increase without limits but cannot fall below zero.
The uncertain variable is positively skewed, with most of the values near the lower limit.
The natural logarithm of the uncertain variable yields a normal distribution.

Generally, if the coefficient of variability is greater than 30 percent, use a lognormal distribution. Otherwise, use the normal distribution. The mathematical constructs for the lognormal distribution are as follows:

$$f ( x ) = \frac{1}{x \sqrt{2 π} ln ( σ )} {e}^{- \frac{{[ ln ( x ) - ln ( μ ) ]}^{2}}{{2 [ ln ( σ ) ]}^{2}}}$$

$$for x > 0 ; μ > 0 and σ > 0$$

$$mean = exp ( μ + \frac{{σ}^{2}}{2} )$$

$$standard deviation = \sqrt{exp ( {σ}^{2} + 2 μ ) [ exp ( {σ}^{2} ) - 1 ]}$$

$$skewness = ⌊ \sqrt{exp ( {σ}^{2} ) - 1} ⌋ ( 2 + exp ( {σ}^{2} ) )$$

$$excess kurtosis = exp ( 4 {σ}^{2} ) + 2 exp ( 3 {σ}^{2} ) + 3 exp ( 2 {σ}^{2} ) - 6$$

Mean (μ) and standard deviation (σ) are the distributional parameters. The input requirements are such that Mean and Standard deviation are both >0 and can be any positive value. By default, the lognormal distribution uses the arithmetic mean and standard deviation. For applications for which historical data are available, it is more appropriate to use either the logarithmic mean and standard deviation, or the geometric mean and standard deviation.

Normal Distribution

The normal distribution is the most important distribution in probability theory because it describes many natural phenomena, such as people's IQs or heights. Decision makers can use the normal distribution to describe uncertain variables such as the inflation rate or the future price of gasoline. The three conditions underlying the normal distribution are:
Some value of the uncertain variable is the most likely (the mean of the distribution).
The uncertain variable could as likely be above the mean as it could be below the mean (symmetrical about the mean).
The uncertain variable is more likely to be in the vicinity of the mean than further away.

The mathematical constructs for the normal distribution are as follows:

$$f ( x ) = \frac{1}{\sqrt{2 π} σ} {e}^{- \frac{{( x - μ )}^{2}}{2 {σ}^{2}}} for all values of x and μ ; while σ > 0$$

$$mean = μ$$

$$standard deviation = σ$$

$$skewness = 0 ( this applies to all inputs of mean and standard deviation )$$

$$excess kurtosis = 0 ( this applies to all inputs of mean and standard deviation )$$

Mean (μ) and standard deviation (σ) are the distributional parameters. The input requirements are such that Standard deviation >0 and can be any positive value and Mean can be any value.

Pareto Distribution

The Pareto distribution is widely used for the investigation of distributions associated with such empirical phenomena as city population sizes, the occurrence of natural resources, the size of companies, personal incomes, stock price fluctuations, and error clustering in communication circuits.

The mathematical constructs for the pareto are as follows:

$$f ( x ) = \frac{β {L}^{β}}{{x}^{( 1 + β )}} for x > L$$

$$mean = \frac{β L}{β - 1}$$

$$standard deviation = \sqrt{\frac{β {L}^{2}}{{( β - 1 )}^{2} ( β - 2 )}}$$

$$skewness = \sqrt{\frac{β - 2}{β}} [ \frac{2 ( β + 1 )}{β - 3} ]$$

$$excess kurtosis = \frac{6 ( {β}^{3} + {β}^{2} - 6 β - 2 )}{β ( β - 3 ) ( β - 4 )}$$

Location (L) and shape (β) are the distributional parameters.

There are two standard parameters for the Pareto distribution: location and shape. The location parameter is the lower bound for the variable. After you select the location parameter, you can estimate the shape parameter. The shape parameter is a number greater than 0, usually greater than 1. The larger the shape parameter, the smaller the variance and the thicker the right tail of the distribution. The input requirements are such that Location >0 and can be any positive value while Shape ≧0.05.

Student's t Distribution

The Student's t distribution is the most widely used distribution in hypothesis test. This distribution is used to estimate the mean of a normally distributed population when the sample size is small, and is used to test the statistical significance of the difference between two sample means or confidence intervals for small sample sizes.

The mathematical constructs for the t-distribution are as follows:

$$f ( x ) = \frac{Γ [ ( r + 1 ) / 2 ]}{\sqrt{r π} Γ [ r / 2 ]} {( 1 + {t}^{2} / r )}^{- ( r + 1 ) / 2}$$

$$mean = 0 ( \begin{matrix}this applies to all degrees of freedom r except if the \\ distribution is shifted to another nonzero central location\end{matrix} )$$

$$standard deviation = \sqrt{\frac{r}{r - 2}}$$

$$skewness = 0$$

$$excess kurtosis = \frac{6}{r - 4} for all r > 4$$

$$where t = \frac{x - \overline{x}}{s} and Γ is the gamma function .$$

Degree of freedom r is the only distributional parameter. The t-distribution is related to the F-distribution as follows: the square of a value of t with r degrees of freedom is distributed as F with 1 and r degrees of freedom. The overall shape of the probability density function of the t-distribution also resembles the bell shape of a normally distributed variable with mean 0 and variance 1, except that it is a bit lower and wider or is leptokurtic (fat tails at the ends and peaked center). As the number of degrees of freedom grows (say, above 30), the t-distribution approaches the normal distribution with mean 0 and variance 1. The input requirements are such that Degrees of freedom ≧1 and must be an integer.

Triangular Distribution

The triangular distribution describes a situation where you know the minimum, maximum, and most likely values to occur. For example, you could describe the number of cars sold per week when past sales show the minimum, maximum, and usual number of cars sold. The three conditions underlying the triangular distribution are:
The minimum number of items is fixed.
The maximum number of items is fixed.
The most likely number of items falls between the minimum and maximum values, forming a triangular-shaped distribution, which shows that values near the minimum and maximum are less likely to occur than those near the most-likely value.

The mathematical constructs for the triangular distribution are as follows:

$$f ( x ) = \{ \begin{matrix}\frac{2 ( x - Min )}{( Max - Min ) ( Likely - min )} for Min < x < Likely \\ \frac{2 ( Max - x )}{( Max - Min ) ( Max - Likely )} for Likely < x < Max\end{matrix} \\ mean = \frac{1}{3} ( Min + Likely + Max ) \\ standard deviation = \sqrt{\frac{1}{18} ( {Min}^{2} + {Likely}^{2} + {Max}^{2} - MinMax - MinLikely - MaxLikely )} \\ skewness = \frac{\begin{matrix}\sqrt{2} ( Min + Max - 2 Likely ) ( 2 Min - Max - Likely ) \\ ( Min - 2 Max + Likely )\end{matrix}}{5 {( \begin{matrix}{Min}^{2} + {Max}^{2} + {Likely}^{2} - MinMax - \\ MinLikely - MaxLikely\end{matrix} )}^{3 / 2}} \\ excess kurtosis = - 0.6$$

Minimum (Min), most likely (Likely) and maximum (Max) are the distributional parameters and the input requirements are such that Min≦Most Likely≦Max and can take any value, Min<Max and can take any value.

Uniform Distribution

With the uniform distribution, all values fall between the minimum and maximum and occur with equal likelihood. The three conditions underlying the uniform distribution are:
The minimum value is fixed.
The maximum value is fixed.
All values between the minimum and maximum occur with equal likelihood.

The mathematical constructs for the uniform distribution are as follows:

$$f ( x ) = \frac{1}{Max - Min}$$

$$for all values such that Min < Max$$

$$mean = \frac{Min + Max}{2}$$

$$standard deviation = \sqrt{\frac{{( Max - Min )}^{2}}{12}}$$

$$skewness = 0$$

$$excess kurtosis = - 1.2 ( this applies to all inputs of Min and Max )$$

Maximum value (Max) and minimum value (Min) are the distributional parameters. The input requirements are such that Min<Max and can take any value.

Weibull Distribution (Rayleigh Distribution)

The Weibull distribution describes data resulting from life and fatigue tests. It is commonly used to describe failure time in reliability studies as well as the breaking strengths of materials in reliability and quality control tests. Weibull distributions are also used to represent various physical quantities, such as wind speed. The Weibull distribution is a family of distributions that can assume the properties of several other distributions. For example, depending on the shape parameter you define, the Weibull distribution can be used to model the exponential and Rayleigh distributions, among others. The Weibull distribution is very flexible. When the Weibull shape parameter is equal to 1.0, the Weibull distribution is identical to the exponential distribution. The Weibull location parameter lets you set up an exponential distribution to start at a location other than 0.0. When the shape parameter is less than 1.0, the Weibull distribution becomes a steeply declining curve. A manufacturer might find this effect useful in describing part failures during a burn-in period.

The mathematical constructs for the Weibull distribution are as follows:

$$f ( x ) = {\frac{α}{β} [ \frac{x}{β} ]}^{α - 1} {e}^{- {( \frac{x}{β} )}^{α}}$$

$$mean = β Γ ( 1 + {α}^{- 1} )$$

$$standard deviation = {β}^{2} [ Γ ( 1 + 2 {α}^{- 1} ) - {Γ}^{2} ( 1 + {α}^{- 1} ) ]$$

$$skewness = \frac{2 {Γ}^{3} ( 1 + {β}^{- 1} ) - 3 Γ ( 1 + {β}^{- 1} ) Γ ( 1 + 2 {β}^{- 1} ) + Γ ( 1 + 3 {β}^{- 1} )}{{[ Γ ( 1 + 2 {β}^{- 1} ) - {Γ}^{2} ( 1 + {β}^{- 1} ) ]}^{3 / 2}}$$

$$excess kurtosis = \frac{\begin{matrix}- 6 {Γ}^{4} ( 1 + {β}^{- 1} ) + 12 {Γ}^{2} ( 1 + {β}^{- 1} ) Γ ( 1 + 2 {β}^{- 1} ) - 3 {Γ}^{2} ( 1 + 2 {β}^{- 1} ) - \\ 4 Γ ( 1 + {β}^{- 1} ) Γ ( 1 + 3 {β}^{- 1} ) + Γ ( 1 + 4 {β}^{- 1} )\end{matrix}}{{[ Γ ( 1 + 2 {β}^{- 1} ) - {Γ}^{2} ( 1 + {β}^{- 1} ) ]}^{2}}$$

Location (L), shape (α) and scale (β) are the distributional parameters, and Γ is the Gamma function. The input requirements are such that Scale >0 and can be any positive value, Shape ≧0.05 and Location can take on any value.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention.

Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer program product for providing health plan financial analysis with respect to employer sponsored insurance and non-insurance alternatives comprising:
a non-transitory computer-readable medium; and
computer program code, encoded on the computer-readable medium, comprising computer-readable instructions for:
determining premium tax credit eligibility status, premium tax credit amounts, cost sharing reduction eligibility and subsidies;
determining employer and employee shared responsibility requirements;
performing a detailed cost analysis for each option an employer studies in making their financial assessment toward the continuation, adjustment or termination of employer sponsored health-care coverage;
receiving input assumptions, wherein said input assumptions are one or more employer-specific parameters entered that relate to the health-care coverage for the employees and dependents of the employer;
calculating economic results, wherein said economic results detail the expansion of multiple employer health-care cost options based on the input assumptions;
creating an indifference analysis graph, wherein a chart is plotted to provide a visual comparison of the economic results;
computing simulation analytics, wherein risk simulation is used improve a confidence level in a choice of said one or more employer health-care cost options;
calculating the employer tax shift, wherein the tax consequences to an employee are estimated based upon the selection of the termination of employer-sponsored health-care coverage option by the employer;
determining employee income expansion, wherein said employee income expansion is the greater of actual employer-reported income and the income from the U.S. Census Bureau Economic Census data sourced by geography and number of dependents;
determining premium tax credit calculation basis, wherein said premium tax credit calculation basis is selected between the total number of dependents or only the employee; and
determining an allocation distribution model, wherein said allocation distribution model applies multiple methods of distributing savings generated by the health-care coverage option selected by the employer.

2. The computer program product of claim 1, wherein said input assumptions are selected from a group of input assumptions comprising general information, demographic information, plan level value selection, deductible level, out-of-pocket limit, employer contribution percentage, and coverage tier contribution.

3. The computer program product of claim 1, wherein said one or more employer health-care cost options are selected from a group of cost options comprising an employer-sponsored coverage model, a no employer sponsored coverage model, and a hybrid coverage model.

4. The computer program product of claim 1, wherein said indifference analysis graph is modified by one or more input factors selected from the group of input factors comprising effective employer contribution percentages, targeted actuarial plan values, eligibility classifications for included and excluded employees, and the effective net cost shift to the employee as percentage of the total.

5. The computer program product of claim 1, wherein said risk simulation is a Monte Carlo risk simulation designed to improve the confidence level by illustrating a larger universe of representative employers with a random mix of possible employee combinations and a resulting financial outcome.

6. The computer program product of claim 1, wherein said one or more methods of distributing savings is selected from a group of distribution methods comprising no distribution, auto distribution, aggregate distribution, and per-employee distribution.

7. A programmed computer system for health plan financial analysis with respect to employer sponsored insurance and non-insurance alternatives comprising:
a processor;
a memory coupled to said processor, the memory having processor executable instruction stored therein, the execution of said processor executable instructions comprising:
a premium tax credit calculation module, wherein said premium tax credit calculation module is configured to determine premium tax credit eligibility status and premium tax credit amount;
an exceptions report module, wherein said exceptions report module is designed to calculate the financial impact of the options available to an employer in managing the minimum affordability requirement through salary or contribution adjustments or assuming the penalty risk;
a rapid economic justification module, wherein said rapid economic justification module is configured to:
receive input assumptions, wherein said input assumptions are employer centric parameters used in combination with simulation to calculate representative economic results,
calculate economic results, wherein said economic results detail three specific employer sponsored insurance and non-insurance options based on the input assumptions,
create an indifference analysis graph, wherein a chart is plotted to provide a visual comparison of the economic results, and
compute simulation analytics, wherein risk simulation is used improve a confidence level in a choice of said one or employer more health-care cost options;
and an options variables module, wherein said options variables module is configured to:

8. The programmed computer system of claim 7, further comprising a communications means operably connected to said processor and said memory.

9. The programmed computer system of claim 7, wherein said input assumptions are selected from a group of input assumptions comprising general information, demographic information, plan level value selection, deductible level, out-of-pocket limit, employer contribution percentage, and coverage tier contribution.

10. The programmed computer system of claim 7, wherein said one or more employer health-care cost options are selected from a group of cost options comprising an employer-sponsored coverage model, a no employer-sponsored coverage model, and a hybrid coverage model.

11. The programmed computer system of claim 7, wherein said indifference analysis graph is modified by one or more input factors selected from the group of input factors comprising effective employer contribution percentages, targeted actuarial plan values, eligibility classifications for included and excluded employees, and the effective net cost shift to the employee as percentage of the total.

12. The programmed computer system of claim 11, wherein one or more input factors are adjusted via a dialer interface.

13. The programmed computer system of claim 7, wherein said risk simulation is a Monte Carlo risk simulation designed to improve the confidence level by illustrating a larger universe of representative employers with a random mix of possible employee combinations and a resulting financial outcome.

14. The programmed computer system of claim 7, wherein said one or more methods of distributing savings is selected from a group of distribution methods comprising no distribution, auto distribution, aggregate distribution, and per-employee distribution.

15. A computer-implemented method for health-care plan selection, said method comprising the steps of:
determining premium tax credit eligibility status, premium tax credit amounts, cost sharing reduction eligibility and subsidies;
determining employer and employee shared responsibility requirements;
performing a detailed cost analysis for each option an employer studies in making their financial assessment toward the continuation, adjustment or termination of employer sponsored health-care coverage;
receiving input assumptions, wherein said input assumptions are one or more employer specific parameters entered that relate to the health-care coverage for the employees and dependents of the employer;
calculating economic results, wherein said economic results detail the expansion of multiple employer health-care cost options based on the input assumptions;
creating an indifference analysis graph, wherein a chart is plotted to provide a visual comparison of the economic results;
computing simulation analytics, wherein risk simulation is used improve a confidence level in a choice of said employer one or more health-care cost options;
calculating the employer tax shift, wherein the tax consequences to an employee are estimated based upon the selection of the termination of employer sponsored health-care coverage option by the employer;
determining employee income expansion, wherein said employee income expansion is the greater of actual employer-reported income and the income from the US Census Bureau Economic Census data sourced by geography and number of dependents;
determining premium tax credit calculation basis, wherein said premium tax credit calculation basis is selected between the total number of dependents or only the employee; and
and
determining an allocation distribution model, wherein said allocation distribution model applies multiple methods of distributing savings generated by the health-care coverage option selected by the employer.

16. The computer-implemented method of claim 15, wherein said input assumptions are selected from a group of input assumptions comprising general information, demographic information, plan level value selection, deductible level, out-of-pocket limit, employer contribution percentage, and coverage tier contribution.

17. The computer-implemented method of claim 15, wherein said one or more employer health-care cost options are selected from a group of cost options comprising an employer-sponsored coverage model, a no employer sponsored coverage model, and a hybrid coverage model.

18. The computer-implemented method of claim 15, wherein said indifference analysis graph is modified by one or more input factors selected from the group of input factors comprising effective employer contribution percentages, targeted actuarial plan values, eligibility classifications for included and excluded employees, and the effective net cost shift to the employee as percentage of the total.

19. The computer-implemented method of claim 15, wherein said risk simulation is a Monte Carlo risk simulation designed to improve the confidence level by illustrating a larger universe of representative employers with a random mix of possible employee combinations and a resulting financial outcome.

20. The computer-implemented method of claim 15, wherein said one or more methods of distributing savings is selected from a group of distribution methods comprising no distribution, auto distribution, aggregate distribution, and per-employee distribution.
